(19) United States
(12) Patent Application Publication
(10) Pub. No.: US 2008/0142407 A1
(43) Pub. Date: Jun. 19, 2008

(54) Apparatus for and Method of Forming Containers and Container Blank Having Content Retaining Web Attached Thereto

(76) Inventor: Alistair Fraser Moore, Suffolk (GB)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/664,069

(22) PCT Filed: Sep. 27, 2005
(86) PCT No.: PCT/GB05/03703

§ 371 Date: Dec. 6, 2007

(30) Foreign Application Priority Data
Sep. 27, 2004 (GB) 0421388.0
Nov. 22, 2004 (GB) PCT/GB04/04935

(51) Int. Cl. B65D 5/50; B65D 81/07; B31B 1/00; B31B 49/02; B31B 1/62

(52) U.S. Cl. 206/583; 229/126; 156/510; 29/650; 493/345; 156/256; 53/285; 53/476

(57) ABSTRACT

A container or container dank (100, 200, 300) comprises a pair of opposed side wall portions and an opposed front wall portion and rear wall portion, each wall portion being connected to a base portion at a fold line and at least one opposed pair of walls being provided with a lid section. At least one portion has a web of material (12, 230, 330) adapted to retain an article within a container formed from the blank (100, 200, 300). Apparatus for and methods of forming a container blank having a web attached thereto and apparatus for and methods of forming a container from a material web lined dank are disclosed with reference to the direction in which the improved tension characteristics of the web are applied. An apparatus and method for filing, closing and sealing an open-mouthed container is also disclosed.

### FIELD OF THE INVENTION

The present invention relates to an apparatus for and method of forming containers for use in packaging articles, particularly the packaging of irregular shaped articles or multiple flat articles, such as books or video cassettes and disks such as LP records, CDs, CD-ROMs and DVDs packed together in a container. The invention is directed particularly to the use of standard retail sale case and rolled, slotted and creased or similar containers (hereinafter referred to as a standard retail container or RSC container). The invention further relates to a container blank and an apparatus and method of forming the blank. The invention yet further relates to a container package (that is, including packaged articles) constructed using the apparatus, method and/or blank of the invention. The invention most particularly relates to the method and apparatus used to form and handle a container blank and to shape the blank into a package for constraining at least one article therein for dispatch or storage.

The invention particularly relates to an apparatus for and method of modifying container blanks made of card or similar material, the blanks being modified to include an article retaining means to secure articles therein and prevent damage-causing movement within the container formed from the blank. Additionally, the invention relates to a container forming machine which takes container blanks having an article retaining means and forms packaging containers for irregularly shaped or particularly heavy articles, such as machine parts, and articles having a relatively large surface area as compared to the associated thickness or depth thereof, such as books, video cassettes and discs of various formats. These articles need to be held securely within the container to prevent damage thereof during transit. A method of forming containers is also disclosed.

The methods, apparatus, blanks and final package as described hereinbelow are described primarily with reference to flat articles such as those exemplified above, however it should be appreciated that no such limitation exists.

It will be appreciated by the skilled addressee that the invention may be applied to any three-dimensional object locatable within the container and is not limited to similarly shaped articles such as books and video cassettes.

### BACKGROUND TO THE INVENTION

Increasingly, customers are eschewing the time-consuming routine of travelling to purchase their shopping and/or business needs. It is now common for purchases to be made by mail order, telephone and via the Internet and email. As a consequence, for goods to be received there is a market increase in the use of postal and courier services to deliver the purchases.

The further involvement of postal services and other delivery systems is different from the traditional mode of shopping where the customer travels to purchase articles over the counter and returns using public or their own transport means. In this scenario, packing or packaging is done at the counter or before the customer leaves, after which responsibility for damage no longer resides with the seller. As most postal and courier services either limit their liability for damage to articles delivered by them or charge significant premiums for insurance against such damage, it falls to the retailer, warehouseman or company dispatching the purchase to ensure there is minimal risk of damage or loss during transit to the customer. The term “postal” as used herein is intended as a convenient expression of all local, national and international dispatch and courier services, including drop-shipping services.

With the increased popularity of Internet shopping and the dispatch of ordered articles via the postal system the requirement for packaging has increased manyfold. The popularity of such websites as Amazon™ and eBay™ have increased the postal traffic of common items such as books, CDs, CDROMs and DVDs and less regularly posted items from vehicle and machine parts to laptop computers and fragile ornaments. Due to the vast turnover of dispatched articles and the inherent risks associated with the bulk handling of goods, there is a market requirement for sturdy containers. Additionally, as the volume of mail order catalogue business increases so to does the volume of returns. This has a severe consequence on the profitability of the mail order transaction and, where the returned article is damaged, the customer must bear responsibility for the damage. This condition of sale often has repercussions for customer relationships. Additionally, if the article has sharp or irregular edges, it can damage the container and, exceptionally, be lost or injure a package handler.

In other words, a fundamental requirement of any method of goods transportation is that the goods are not damaged during transport so that they reach their destinations in a non-damaged state.

It has been found in practice, that the packaging of articles such as books, records, and similar articles having at least one surface with a relatively large surface area in relation to depth or thickness of the article has presented, in terms of packaging, a significant ongoing problem. This problem manifests itself particularly in situations where the articles are packaged on a production line basis by a packaging method involving the folding of a card or the like blank into a container for receiving an article to be packed. There are additional problems associated with the packaging of irregular shaped or heavy articles, as noted above.

Containers formed from blanks made of card and cardboard and other materials suitable for dispatch through the postal services are well known in the prior art. Generally, the containers are formed from a relatively simple blank having side walls separated by fold lines and one or more base and lid portions connected to one or more of the side walls by corresponding fold lines. To construct the container an end tab of one side wall is secured to an edge portion of another side wall and the or each base portion is folded and secured to form an open-mouthed container. When the or each article to be dispatched has been placed within the container, the or each lid portion is folded and secured. The means of securing the portions to form the container is normally selected from gluing or stapling.

There are many examples of the above types of container in the prior art, in addition to the standard RSC type container, a modified arrangement of which is discussed hereinbelow with respect to the detailed embodiments of the present invention.

It will be appreciated that unless the container is designed to receive the specific article(s) to be dispatched, further packaging materials will be required to prevent the article(s) moving about within the container. This is particularly so with respect to irregularly shaped articles and the use of polystyrene filling material (sometimes referred to as “peanuts”). Small pieces of filler material will not however prevent heavy objects moving within a container. In the packaging industry generally there is a move to obviate extraneous packaging materials and in some countries there are regulations and legislation to prevent wasteful packaging practices.

The invention is directed to overcoming some of the established disadvantages associated with prior art containers, particularly those realising a container which is adapted for encapsulating or otherwise securing one or more articles within the container to prevent damage due to movement within the container during transit to its destination.

In an attempt to obviate some of the disadvantages highlighted above, a solution suggested in the prior art is to utilise a web of lining material to secure the articles within the container.

One established solution is to place the articles for dispatch in a tray, usually of a cardboard material. The tray and articles are then wrapped by a web of plastics material which is subsequently heated to effect a shrink-wrapped package. Alternatively, the web or film is tensioned around the article(s) by folding elements of the tray to which the web is attached. This package is then placed into a pre-formed container which is finally sealed and marked for dispatch. This arrangement, however, has its own disadvantages including that, although the articles are bound together, the tray will often move sufficiently in the container to dislodge the articles from the tray. Furthermore, this arrangement does not avoid the use of unnecessary additional packaging materials and includes an extra stage in the packaging process.

In another solution proposed by the Applicant in United Kingdom Patent No. GB 2 343 885 (which is incorporated herein by reference) there is described a container blank to which a sheet or web of lining material is secured. This lining material is shrink-wrappable so that articles may be placed directly into the container and secured in situ.

Although providing significant improvements over the prior art, the container and container blank disclosed in GB 2 343 885 is not suitable for machine forming into a container. While there is significant demand for containers which are manually formed (particularly for low volume operation), high volume dispatch centres or drop-shippers, for example, require fully automated systems. The advantages of machine forming of a container from a blank will be apparent to the skilled addressee.

For cost reasons and to adhere to requirements, in particular those relating to crush resistance, it is desirable to make use of the inherent strength provided by the “nape” of corrugations formed within the cardboard material. It is for this reason, together with the low failure rate of such material, that multi-ply, high-grade cardboard materials are considered despite their relative expense and the accuracy to which the blanks must be formed. Where inexpensive materials are used, the proportion of failures and machinery wear increases, consequently machine downtime and process stoppages deleteriously affect efficiency.

From reading the prior art, it is known that container blanks are usually formed using a die-cutting technique which includes stamping of fold lines. A range of standard retail sales case are formed using large knife bearing rollers into which cardboard material is fed to be “rolled, slotted and creased” to form container blanks. The blanks are then introduced to a folding station where a container is formed. The open-mouthed container is then filled and sealed for dispatch. In an alternative prior art arrangement, the article(s) to be packaged is/are placed onto a blank and passed to a sealing station where the container is formed around the article(s) and sealed using hot-melt glue.

It is an object of the present invention to provide a packaging system that seeks to alleviate the disadvantages associated with the prior art and seeks to minimise(s) the risk of damage to an article during post, packaging, handling and during transit.

Accordingly, it is an object of the invention to provide a container blank suitable for machine forming and to provide a container so formed for receiving articles to be secured therein prior to dispatch.

It is a further object of the invention to provide an apparatus for forming container blanks of the invention.

It is an additional object of the invention to provide an apparatus for forming and filling containers for dispatch at high speed and which facilitates the use of standard electronic interfaces and control instrumentation.

It is a yet further object of the present invention to provide a method for the forming and filling of containers in accordance with the invention.

### SUMMARY OF THE INVENTION

Accordingly, the present invention provides a container or container blank comprising:

a pair of opposed side wall portions and an opposed front wall portion and rear wall portion, each wall portion being connected to a base portion at a fold line and at least one opposed pair of walls being provide with a lid section; and

at least one portion having attached thereto a web of material adapted to retain an article within the container or a container formed from the blank, wherein the material web is secured to the at least one portion using adhesive applied in a direction consistent with the direct along which tension is applied to retain an article within the container.

In one arrangement of container or container blank:

the side wall portions and front and rear wall portions are connected to a common base portion at respective fold lines:

each side wall portion has inner and outer sections, separated by a fold land, the sections being adapted for folding about the fold land to assume a position overlying one another, the outer section including locking means engagable in the base portion to secure said overlying position; and

the front and rear wall portions each have a riser section and a lid section.

In another arrangement of container or container blank, each wall portion has a base portion and lid section attached thereto at fold lines and is connected to at least one adjacent wall portion at a fold line disposed perpendicularly to the base or lid fold lines.

Advantageously, the material web is secured to the at least one portion using adhesive applied in a direction consistent with the direction in which the web is applied.

Preferably, the adhesive is selected from hot melt glue, cold-seal contact adhesive, double-sided adhesive tape or like material.

Conveniently, the material adapted to retain an article within the container or container formed from the blank is a shrink-wrappable material.

Optionally, the material adapted to retain an article within the container or container formed from the blank includes an adhesive coated section having an adhesive material adapted to adhere substantially exclusively to like coated sections.

Advantageously, the material web includes at least one adhesive coated section to which a removable liner is applied.

Conveniently, the material web includes a release coat.

Advantageously, at least the side, front and rear wall portions are so sized and shaped as to be machine foldable.

Preferably, the container or container blank is cut from a card material having a nape oriented to add to the strength of the container or container formed from the blank.

In one construction, the web is applied discontinuously. This construction utilises a plurality of discrete lengths or patches of article retaining material positioned on a container blank so as to secure effectively articles for dispatch placed in a container formed from the blank.

The present invention further provides an apparatus for forming a container blank of the type having an article retaining means thereon, the apparatus comprising:

means for dispensing onto a feed conveyor a substantially continuous supply of container blanks, the blanks being of a desirous pre-formed profile having a plurality of foldable sections so shaped and sized as to form a container:

means for applying adhesive,

means for dispensing a web of a retaining material and laying a length of said web onto the inner surface of said blank:

cutting means to slice the web to define the length of web adhered to the blank; and

conveying means to carry the blank thus formed to a stacking station, a storage station or for further processing.

Advantageously, the apparatus includes a pressure applying means for bonding the web material to the inner surface of the blank.

Conveniently, the means for dispensing a supply of blanks comprises a support table having a vacuum operated picker mechanism which individually selects a blank from the base of a magazine of blanks and introduces the blank to an adhesive application station.

Advantageously, the table includes a blank edge support means for retaining the blanks within the magazine, the picker mechanism engaging the base portion of the selected blank and deflecting it to disengage said edge support means.

Optionally, the means for dispensing a supply of blanks comprises a means for conveying a stack of blanks to a vacuum operated picker mechanism which is adapted to select individually the trailing edge region of a blank and introduce the leading edge thereof to an adhesive application station.

Ideally, the vacuum picker mechanism is mounted on a carriage adapted for parallel movement with respect to the direction of travel of the blanks, whereby successive blanks are peeled from underlying blanks in a stack of blanks.

In an alternative construction, the means for dispensing a supply of blanks comprises a pair of lift tables mounted on a carriage adapted for lateral movement with respect to the direction of travel of blanks within the apparatus, the dispensing means including a vacuum operated picker mechanism which individually selects a blank from the top of a magazine of blanks and introduces the blank to an adhesive application station.

Preferably, the means for applying adhesive comprises a plurality of nozzles for applying at least one strip of a flowable adhesive to an inner surface of the blank.

Alternatively, the means for applying adhesive comprises a tape dispenser for applying double-sided adhesive tape to a length of said web or to the inner surface of said blank.

In one arrangement, the cutting means defines first and second lengths of web material adhered to the blank.

Conveniently, the conveying means includes a forming station adapted to fold the blank into a profile suitable for stacking or as an intermediate container forming stage.

Preferably, the forming station includes as adhesive application station.

Additionally or alternatively, the forming station includes a stapling means.

The present invention yet further provides a method for forming a container blank of the type having an article retaining portion thereon, the method comprising:

dispensing onto a feed conveyor a substantially continuous supply of container blanks, the blanks being of a desirous pre-formed profile having a plurality of foldable sections so shaped and sized as to form a container;

applying at least one strip of adhesive for bonding a web of retaining material to inner surface of the blank;

dispensing the web of a retaining material and laying a length of said web onto the inner surface of said blank;

cutting the web to define the length of web adhered to the blank; and

conveying the blank thus formed to a stacking station, a storage station or for further processing.

Preferably, the method includes applying pressure to the inner surface of the blank to bond the web material thereto.

In one arrangement, first and second lengths of web are cut and adhered to the blank.

In another arrangement, the or each strip of adhesive is applied to the web of retaining material.

In an alternative arrangement, in which the or each strip of adhesive is applied via a tape dispenser.

In the preferred arrangement, the or each strip of adhesive is applied to the inner surface of the blank via a plurality of nozzles.

The present invention further provides an apparatus for forming a container from a container blank of the type having an article retaining portion thereon, the apparatus comprising:

a feeding station for dispensing onto a feed conveyor a substantially continuous supply of container blanks, each blank having a length of web material adhered thereto and having a plurality of foldable sections so shaped and sized as to form a container; and

a container forming station having at least one actuator member to abut or grip a portion of the container blank so as to cause sections of the blank to move about pre-formed score lines so that the blank assumes the form of an open-mouthed container.

In one arrangement of apparatus for forming a container, the at least one actuator member abuts the inner surface of the base portion of the container blank and forces the blank into a container-forming die, the die being so formed and shaped as to cause sections of the blank to fold about pre-formed score lines.

In an alternative arrangement of apparatus, the at least one actuator member is a vacuum operated mechanism adapted to open a folded container blank so as to facilitate forming of a container base from a plurality of base portions, whereupon the blank assumes the form of an open-mouthed container.

Preferably, the apparatus includes any one or more of:

at least one packing station where one or more articles are placed into the open mouth of the formed container;

an article retaining station where manipulator means bring one end of the web material into position to overlie the other end and adhere the overlying sections together;

lid closing station where the lid portions are brought together in overlying relationship to seal the lid closed; and

a dispatch conveyor which carries the container through final stages or to storage.

Ideally, the feeding station comprises an apparatus for forming a container blank as disclosed hereinabove.

In one construction of apparatus, there is provided a shrink-wrapping station where heat is applied to the overlying ends of shrink-wrappable web material so that the or each article placed in the container at the packing station is secured therein.

In an alternative construction of apparatus for forming a container, pressure-sensitive adhesive is pre-applied to at least one of the lid portions to facilitate sealing of the container at the lid closing station.

Conveniently, the lid closing station comprises at least one tape dispenser to seal the container.

Preferably, the lid closing station includes means for securing the base portions of the container.

In one arrangement, the feeding station comprises a pivotable destacking arm adapted to individually select a blank from magazine of vertically stacked blanks.

In an alternative arrangement, the feeding station comprises a pair of lift tables mounted on a carriage adapted for lateral movement with respect to the direction of travel of blanks within the apparatus, the dispensing means including a vacuum operated picker mechanism which individually selects a blank from the top of a magazine of blanks and introduces the blank to an adhesive application station.

The present invention further provides a method of forming a container from a container blank of the type having an article retaining portion thereon, the method comprising:

dispensing onto a feed conveyor a substantially continuous supply of container blanks, each blank having a length of retaining material adhered thereto and having a plurality of foldable sections so shaped and sized as to form a container; and

abutting or gripping a portion of the container blank with at least one actuator member so as to cause sections of the blank to move about pre-formed score lines so that the blank assumes the form of an open-mouthed container.

In one arrangement, the method includes abutting the inner surface of the base portion of the container blank and forcing the blank into a container-forming die, the die being so formed and shaped as to cause sections of the blank to fold about pre-formed score lines.

In an alternative arrangement, the method includes opening a folded container blank by gripping a surface thereof with a vacuum operated actuator mechanism, forming a container base from a plurality of base portions thereby forming an open-mouthed container.

Preferably, the method includes one or more steps selected from:

placing one or more articles into the open mouth of the formed container;

bringing one end of the retaining material into position to overlie the other end and adhering the overlying sections together;

closing the lid portions in overlying relationship to seal the lid closed; and conveying the container through final stages or to storage; and

conveying the container through final stages or to storage.

Conveniently, the method includes applying heat to the overlying ends of the material so as to secure the or each article placed in the container.

Alternatively, pressure-sensitive adhesive is pre-applied to at least one of the lid portions to facilitate sealing of the container at the lid closing station.

Advantageously, the method includes dispensing and applying adhesive tape to secure the or each lid portion and/or the or each base portion.

The present invention yet further provides an apparatus for feeding open-mouthed containers via a packing station to a sealing and closing station in preparation for dispatch or storage of the packaged articles, the apparatus comprising:

feeding means for conveying open-mouthed containers onto a buffer conveyor;

a stacking conveyor comprising at least one intake conveyor fed by the buffer conveyor;

a discharge conveyor for transporting filled containers from a packing station;

an article securing station where free ends of the retaining material are brought together and bonded to secure the or each article within the container; and

a lid closing means.

In one arrangement, a heating zone is provided for applying heat to a shrink-wrap retaining means within the containers to secure the contents therein.

The invention yet further provides a method of feeding open-mouthed containers via a packing station to a sealing and closing station in preparation for dispatch or storage of the packaged articles, the method comprising:

feeding open-mouthed containers onto a buffer conveyor;

feeding containers from said buffer conveyor to a stacking conveyor;

filling the containers at a packing station and placing the filled containers on a discharge conveyor;

securing free ends of a retaining material by bringing the ends together for bonding to secure the or each article within the container; and

closing and sealing the or each lid portion of the container.

In one arrangement, the method includes applying heat to a shrink-wrappable retaining means within the container to secure the contents therein.

In an alternative arrangement, the method includes removing lining or backing material from the retaining material to expose adhesive thereon and tensioning said material to secure the contents of the container therein.

Additional features of the invention and its advantages, together with further objectives of the invention will be apparent from the detailed description of the preferred embodiments below, when read in conjunction with the accompanying drawings.

### BRIEF DESCRIPTION OF THE DRAWINGS

The invention will now be described more particularly with reference to the accompanying drawings which show, by way of example only, constructions of container blank, apparatus for forming a container blank, methods of constructing a container blank, apparatus for forming a container from a blank and methods of forming a container suitable for dispatch, in accordance with the invention. In the drawings:

FIG. 1a is a plan view of a prior art container blank suitable for packaging articles by manually folding sections of the blank about an article to form a container therefore;

FIGS. 1b and 1c are top plan views of a container formed from the prior art blank of FIG. 1 illustrating the fixing of a plastics material web or sheet thereto and the resultant tension or distribution of the holding forces applied to the article constrained within the container;

FIG. 2a is a plan view of a first container blank in accordance with the invention, the container being both manually and machine foldable;

FIGS. 2b and 2c are top plan views of a container formed from the blank of FIG. 2a illustrating the fixing of a plastics material web or sheet thereto and the resultant tension or distribution of the holding forces applied to the article constrained within the container;

FIG. 3a is a plan view of an apparatus for applying the plastics material sheet to the pre-formed blank of FIG. 2a;

FIG. 3b is a side elevation of the apparatus of FIG. 3a having a first arrangement of blank feeding mechanism for metering one blank at a time into the apparatus;

FIG. 3c is a side elevation of the apparatus of FIG. 3a having a second arrangement of blank feeding mechanism;

FIG. 3d is a first arrangement of blank feeding mechanism comprising a support table for metering blanks to the lining apparatus;

FIGS. 3e(i) to 3e(v) are end elevations on Arrow X of FIG. 3c, showing the second arrangement of blank feeding mechanism;

FIG. 4 is a schematic side elevation of a container forming apparatus;

FIG. 5 is a series of twelve views or vignettes illustrating the initial introduction of the sequential steps of forming a container, including the introduction of subsequent blanks;

FIGS. 6a and 6b are side elevations of the process steps of forming a container from a blank using an alternative arrangement of container forming apparatus;

FIGS. 6c(i) to 6c(v) are end elevations on Arrow X of FIG. 6a, showing an arrangement of blank feeding mechanism, similar to that shown in FIGS. 3e(i) to 3e(v);

FIG. 7 is a schematic plan view of a filling and packing apparatus;

FIGS. 8a to 8c are a plan view, a side elevation and an end elevation of a heat chamber for shrink-wrapping the articles within the containers;

FIGS. 9a and 9b are top plan views of two arrangements of a second embodiment of container blank in accordance with the invention, illustrating the fixing of article retaining material webs thereto;

FIG. 9c is a plan view of an apparatus for forming a container blank of FIG. 9b by applying lengths of material web to successive ones of a stack of profiled blank stock;

FIG. 10a to 10c are a plan view, a side elevation; and an end elevation of an arrangement of blank feeding mechanism for metering successive blanks into the apparatus;

FIGS. 11a and 11b are a schematic perspective view and a schematic side elevation of the apparatus for forming the container blank of FIG. 9b;

FIG. 12 is a series of eight views or vignettes illustrating the sequential steps involved in conveying first and second lengths of article retaining material to a container blank; and

FIG. 13 is a schematic perspective view of the apparatus of FIG. 9c having a discharge conveyor which includes additional forming or folding stations.

### DETAILED DESCRIPTION OF THE DRAWINGS

In the description that follows, the terms “left”, “right”, “upstream” and “downstream” should be regarded with respect to the drawings only and relate to the processing and conveyance of a blank and container formed from the blank as it moves through the apparatus. In this arrangement, “upstream” represents the source of raw material or a yet-to-be-processed container blank and “downstream” towards the accumulation point for storage or dispatch.

The terms “side walls” and “end walls” are used conveniently to describe pairs of opposed walls and should not be considered as limiting. Certain portions or tabs are also described in a similar fashion, again only to assist the reader.

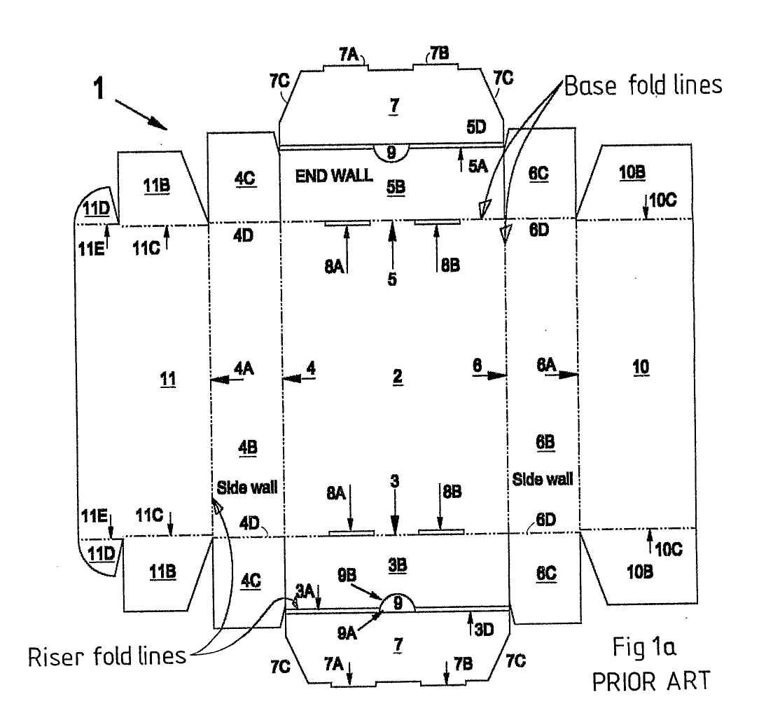

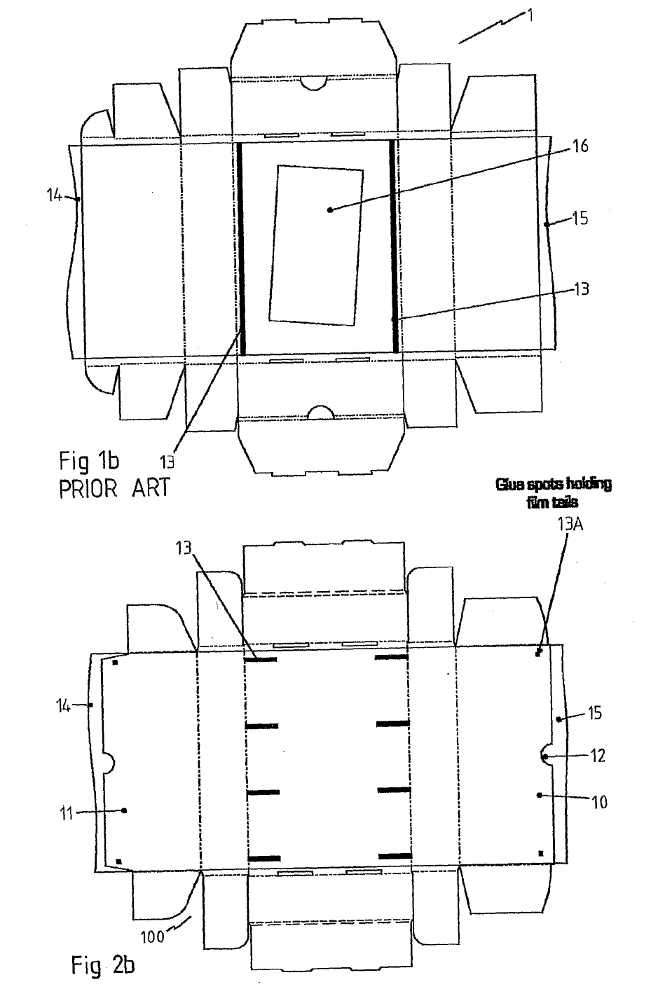

Referring now to the drawings, and initially to FIG. 1a, a prior art arrangement of container blank 1, as disclosed in United Kingdom Patent No. 2 343 885, is shown. The blank 1 is cut from craft card and includes a central land that forms the base 2 of a container formed from the blank. The central land or base 2 is defined by base fold lines 3,4,5,6. Riser fold lines 3A,4A,5A,6A are formed in the blank to run parallel to but spaced from the fold lines 3,4,5,6, respectively, to define end and side walls 3B,5B;4B,6B which in turn define the depth of the container to be formed by the blank.

Referring specifically to each end wall 3B,5B, an over-tab fold line 3D,5D is formed in the blank running parallel to the riser fold line 3A,5A. The distance between the riser fold lines and over-tab fold lines fold lines 3D,5D is effectively twice the thickness of that of the card material from which the blank is formed, for reasons to be mentioned hereinafter. The dimensions of the blank are such that the portion thereof extending outwardly of the over-tab fold lines 3D,5D define tuck-in flaps 7, each having short rectangular extensions 7A,7B that are formed to engage corresponding receiving slots 8A,8B disposed in the base 2 immediately adjacent the end wall base fold lines 3,5.

A removable push-out portion 9 is disposed centrally along the outer edge of each end wall 3B,5B such that the push-out portion 9 includes a substantially rectangular part 9A that bridges the space between the riser fold line 3A,5A and the over-tab fold lines 3D,5D and a semicircular part 9B opening into the end wall itself 3B,5B. End corner regions 7C of the tuck-in flaps 7 are angled to facilitate folding of the blank during the container forming process.

Referring now to the side walls 4B,6B, each end thereof is provided with a tuck-in flap 4C,6C having the same height dimension as the side walls 4B,6B which define the depth of the container to be formed from the blank. The tuck-in flaps 4C,6C are foldable over the end-flap fold lines 4D,6D to be positioned adjacent the inner face of the end walls 3B,5B. Consequently, the tuck-in flaps must be, in its longest dimension, slightly less than half of the width (long dimension) of the end walls 3B,5B but sufficiently long to provide structural support for the container thus formed without encroaching on the area adjacent to the push-out portion 9. The tuck-in flap 4C,6C are parallel components that enhance the overall strength of the finished container. At least one of the free corners of the tuck-in flaps 4C,6C is tapered to facilitate easier folding.

A first lid forming portion 10 extends from one side wall 6B and is connected thereto via the side wall riser fold line 6A. Each end of the first lid portion 10 includes a fold-in flap 10B foldable around a lid-flap fold line 10C. As will be noted from FIG. 1a, a corner of the fold-in flap 10B is shaped to facilitate the manual folding or “tucking-in” of the lid end flap 10B.

The depth of the first lid portion 10, that is from the riser fold line 6A to a free edge 10G of the lid potion 10, the edge 10G essentially comprising the leading edge of the blank 100. It will be noted from FIG. 1a that the width of the first lid portion, that is, the distance between the fold-in flap lines 10C, is less than the distance between the adjacent side wall end-flap fold lines 6D. This is to allow the lid flaps 10B to fold inside the end wall tuck-in flaps 7 when an open-mouthed container is formed.

A second lid portion 11 extends from the other side wall 4B by way of the corresponding riser fold line 4A. This lid forming portion 11 is deeper than the first lid forming portion 10 so that the second lid portion 11 partially overlies the first lid portion 10 when folded over the open-mouthed container when formed.

Similarly to the first lid portion 10, each end of the second lid portion 11 includes a pair of tuck-in flaps 11B that are foldable about lid-flap fold lines 11C that align with the inner long edge of the rectangular slot 8A in the base 2. Each end of the second lid part 11 also includes a second tuck-in flap 11D which folds about a fold line 11E. These second flap fold lines 11E fold outside the lid flap fold lines 11C and are in line with the base fold lines 3,5 of the respective end walls 3B,5B. When folded into position, the second tuck-in flaps 11D engage the aperture defined by the rectangular part 9A of the removable push-out portions 9. The two flaps 11B and 11D are shaped to facilitate the actual tucking-in process.

To form a container from the prior art blank of FIG. 1a, the side walls 4B,6B are folded through 90° at the base fold lines 4,6 into an upright position relative to the base 2. The side wall tuck-in flaps 4C,6C are folded in at a right angle relative to the associated side wall 4B,6B and to align with the other base fold lines 3,5. The end walls 3B,5B are folded to the vertical position relative to the base 2 and the associated outer flap parts 7 are folded inwards firstly over the corresponding riser fold lines 3A,5A and subsequently over the over-tab fold lines 3D,5D to form a sandwich of the side wall tuck-in flaps 4C,6C between the inner surfaces of the end walls 3B,5B and their corresponding tuck-in flaps 7. It will be noted that the semicircular part 9B of the aperture formed by the removal of the push-out portion 9 lies externally of the thus formed end wall. The tuck-in flap extensions 7A,7B are then pushed into engagement with the corresponding receiver slots 8A,8B. This thus defines the form of the open-mouthed container.

The lid tuck-in flaps 10B,11B are folded to a position perpendicular to their respective lid portions 10,11. The shorter tuck-in flaps 11D of the second lid portion 11 are turned to the positions in which they are able to engage the rectangular part 9A of the removable push-out portion 9. The lid portion 10 is then folded along the side wall riser fold line 6A to overlie the base part 2 and the tuck-in flaps 10B of the lid 10 are positioned to lie against the now inwardly facing surface of the end wall tuck-in flaps 7. The second lid portion 11 is subsequently folded along its riser fold line 4A to overlie the open-mouthed container and a proportion of the first lid portion 10. The tuck-in flaps 11B of the second lid portion 11 are also positioned adjacent the exposed surface of the end wall tuck-in flaps 7 and the shorter tuck-in flaps 11D of the lid 11 are engaged in the rectangular aperture 9A.

It will be found that thus folded blank provides a stiff rectangular box-like container.

In practice, in accordance with the requirements of packaging method involved the article to be packed (not shown) is required to be placed at a required location within the thus formed container, the location usually being symmetrically positioned within the dimensions of the base. After such a placement, the blank is folded in the manner discussed around the previously positioned article.

This means that if the size of the article is such that it effectively fills the container the article when in the container is not likely to move about within the container during prior transit. If, however, the article is smaller than the interior of the container it follows that the article would be at least relatively free to displace within the container and thus be prone to possible damage of the article or exceptionally the container during transit. Damage to the container is most likely to occur with heavier objects, such as machine parts.

It will be appreciated that when, for example, a large number of similar articles are to be packed, such as compact discs, books and other flat articles, their thickness can vary within wide ranges. This is also true of single articles selected from a range of products or articles to be packaged and dispatched from a single location. At a retails outlet, for example, customers may request any combination of their various purchases to be delivered.

Also, it is clearly not commercially possible to provide, for every differently sized article, a precisely dimensioned container tailored for each such article so that the article is an exact fit in the container. In view of this it is conventional practice to provide a range of differently sized containers, with each container of the range being intended to accommodate a range of possible sizes of articles. This practice has the result that if an article is an exact fit in the container relative displacement is not likely to occur. Whereas if the article is dimensionally smaller than the maximum size accommodatable by a container any such articles would be effectively free to move about within the container in a manner set by the nature of any post packaging handling.

In order to deal with this problem it is proposed accordance with an aspect of the invention to provide the container forming blank 1 with an auxiliary/inner packaging for the article that is adapted to restrain the article against movement after it is placed at the requires location upon the container base. With this arrangement when the blank is folded into container form, the auxiliary packaging is effectively automatically brought into its displacement restraining condition.

In the above description of the prior art blank, no consideration has been given to the article retaining means which comprises a flexible lining material secured to the base 2 of the blank 1. As schematically shown in FIG. 1b, a sheet or film 12 of lining material is attached to the base 2 by two lines of adhesive 13 applied as continuous lines adjacent the side wall base fold lines 4,6. It will be appreciated by the skilled addressee that the adhesive may be applied as broken lines or over an extended area of the base 2 depending on the attachment strength required. The lining material sheet 12 is large enough to overlie the lid forming portions 10,11 as indicated by the film flaps 14,15 of FIG. 1b.

When packaging an article 16 it is placed on the lining material 12 and the two flaps 14,15 are folded over the article 16. Depending on the nature of the article being packed, the overlying edge regions of the lining material flaps 14,15 are stuck together to hold the article firmly in place. With a manually erected container this can be done either prior to the container being formed from the blank or after.

FIG. 1c schematically illustrates a container of the invention in an open-mouthed configuration in which one or more articles have been constrained using the lining material 12. The lining material covers the base 2 of the container with enough length to overlap each end thereof so as to allow the free ends of the film to be stuck together. Tension lines 17 indicate the restraining mechanism of the film 12. If thought convenient, lines of adhesive are provided around the four sides of the base 2 to hold the lining 12.

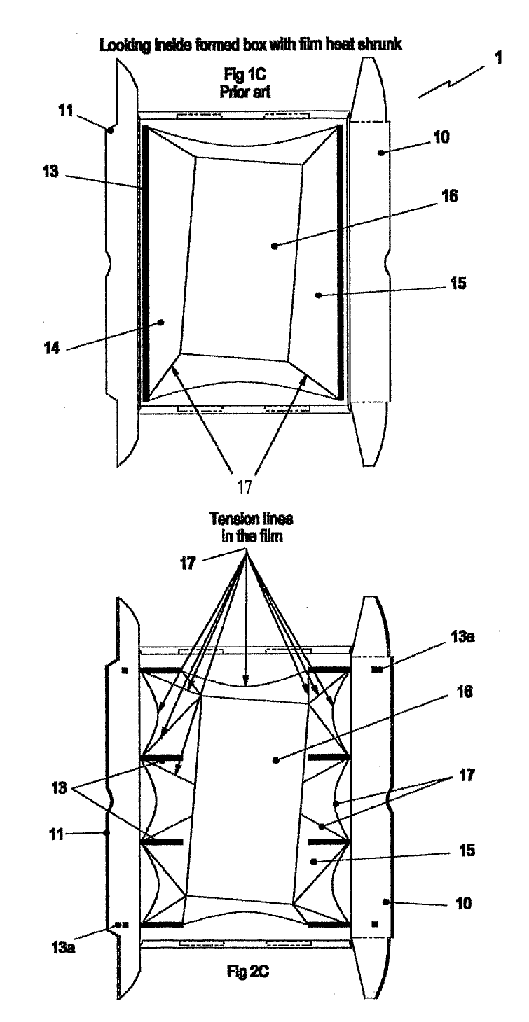

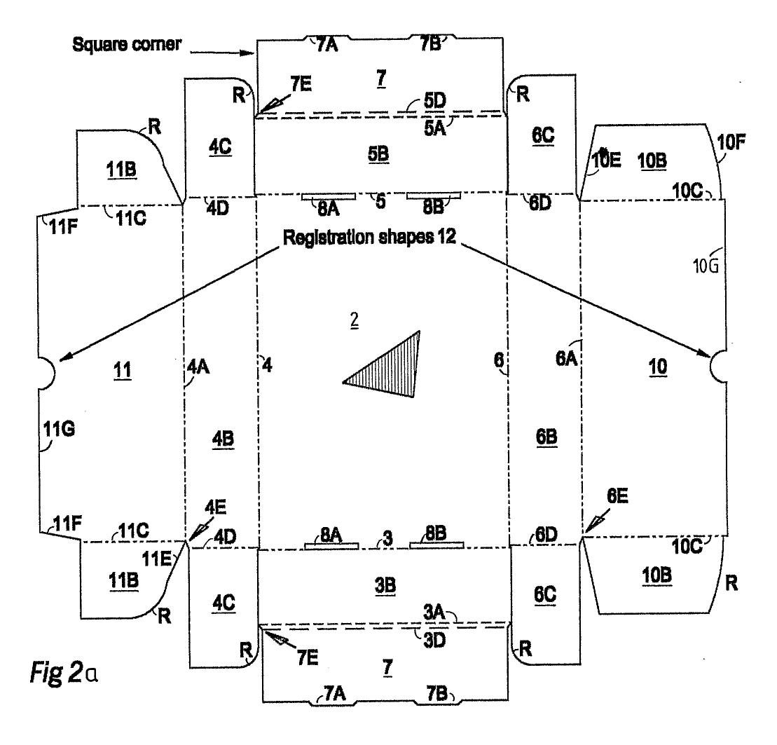

A first embodiment of machine-foldable blank 100 of the present invention will now be described with reference to FIGS. 2a to 2c. For the sake of convenience and consistency of description like portions of the machine foldable blank 100 will be described with numerals common to those used with respect to the prior art blank 1. In common with the prior art blank 1, as described with reference to FIGS. 1a to 1c, the blank 100 is cut from craft card and includes a central land that forms the base 2 of the container formed from the blank 100. The base 2 is defined by fold lines 3,4,5,6 and riser fold lines 3A,4A,5A,6A are formed in the blank 100 to run parallel to but spaced from the base fold lines 3,4,5,6, respectively, to define end and side walls 3B,5B;4B,6B which in turn define the depth of the container to be formed by the blank 100.

Referring specifically to each end wall 3B,5B, an over-tab fold line 3D,5D is formed in the blank running parallel to the riser fold line 3A,5A, the distance between the riser fold lines 3A,5A and the over-tab fold lines 3D,5D being effectively twice the thickness of the card material from which the blank 100 is cut, for the same reasons as described with respect to the prior art blank 1.

The end walls 3B,5B of the blank 100 include tuck-in flaps 7 extending outwardly of the over-tab fold lines 3D,5D. The tuck-in flaps 7 each have short profiled extensions 7A,7B which are formed to engage corresponding receiver slots 8A,8B disposed in the base 2 immediately adjacent the end wall base fold lines 3,5.

It will be noted that the length of the over tab fold lines 3D,5D are marginally shorter than the adjacent riser fold lines 3A,5A so that a bevelled edge is formed to facilitate smooth and rapid machine folding. Similarly, the extensions 7A,7B are profiled to facilitate smooth and rapid machine registration of the tabs 7A,7B into their corresponding receivers 8A,8B. The modified profiles obviate the requirement to profile the distal corners of the tuck-in flaps 7. The square comers of the flaps 7 provide additional rigidity and strength to the container thus formed and facilitates machine forming. More particularly, it should be noted that the end wall riser fold lines 3A,5A are formed using deeper and/or larger perforations than those of the corresponding over-tab fold lines 3D,5D to ensure that the riser fold lines 3A,5A fold before the over-tab fold lines 3D,5D. This is important not only to facilitate the correct formation of the container but also to correctly position the extension tabs 7A,7B for engagement into the corresponding receivers 8A,8B. Ideally, the perforations forming the over-tab fold lines 3D,5D extend 50% of the corresponding number, length or depth (as appropriate) of the perforations forming the end wall riser fold lines 3A,5A.

In comparing the final folding stages of the container formed from the blank 100 of the present invention and that of the exemplifying prior art, as shown in FIG. 1a, it will be noted that the shorter tuck-in flaps 11D of the second lid portion 11 have been removed to allow for machine closing of the lid and that the push-out portion 9 is no longer required. As a consequence of obviating the push-out portion 9, the land formed between the end wall riser fold lines 3A,5A and the over-tab fold lines 3D,5D is continuous along the end wall, thereby strengthening the end wall portions of the container.

Although the above modifications and many of those described hereinbelow are visually insignificant, it has been found that such changes aid folding and forming to a disproportionate degree and, more importantly, facilitate machine folding. Additionally, certain features of the prior art blank 1, particularly those to aid manual handling (such as the removable push-out portions 9 and the flaps 11D inserted therein), are now obviated.

Referring now to each side wall 4B,6B each end thereof is provided with a tuck-in flap 4C,6C having substantially the same height dimension as the side walls 4B,6B which defines the depth of the container to be formed by the blank 100. The tuck-in flaps 4C,6C are foldable over end flap fold lines 4D,6D to be positioned adjacent the inner face of the end walls 3B,5B. Consequently, the tuck-in flaps 4C,6C must be, in their longest dimension, slightly less than half of the width (long dimension) of the end walls 3B,5B and provide significant structural integrity for the end walls. At least one of the free corners of the tuck-in flaps 4C,6C is rounded to facilitate machine folding.

As before, a first lid forming portion 10 extends from one side wall 6B and is connected thereto via the corresponding riser fold lines 6A. Each end of the first lid forming portion 10 includes a fold-in flap 10B foldable around a lid flap fold line 10C. As will be noted from FIG. 2a, the fold-in lid flaps 10B are profiled so that machine folding is facilitated. A first leading side edge 10E of each lid flap 10B is bevelled to provide a straight edge which presents a parallel even edge to the formed end walls 3B,7;5B,7 as the first lid portion 10 is folded towards the now open-mouthed container. A trailing edge 10F of each lid flap 10B has a rounded profile corresponding to the arc transcribed by the lid portion 10 as it is closed over said open-mouthed container.

The depth of the first lid portion 10 is from the riser fold line 6A to a free edge 10G of the lid potion 10, the edge 10G essentially comprising the leading edge of the blank 100. As such there is a registration shape 12 cut into the free edge 10G for positioning the blank within a forming machine. A corresponding registration shape 12 may be formed on a trailing edge 11E of a second lid portion 11. The registration shape assists with the automatic handling of blanks and allows leading edge or trailing edge sensor registration.

The second lid portion 11 extends from the opposite side wall 4B to that of the first lid portion 10, by way of a corresponding riser fold line 4A. This lid portion 11 is wider, from the riser fold line to the trailing edge 11G, than the first lid portion 10 so the second lid portion 11 partially overlies the first lid portion 10 when folded onto the open-mouthed container.

Similarly to the first lid portion 10, the second lid portion 11 includes a pair of tuck-in flaps 11B that are foldable about lid flap fold lines 11C. The leading edge 11E of each lid flap 11B is bevelled and rounded to assure smooth machine folding. Adjacent the trailing edge 11G of the lid 11, bevelled end portions 11F are formed to ensure that the glued-down trailing edge 11G does not present any corners or portions which could be snagged or pulled when the container is closed.

The blank 100 further includes a heat shrinkable lining material 12 which is attached to the base 2, at least. FIGS. 2b and 2c illustrate the layout and use of the lining material or film 12 in conjunction with a machine foldable blank 100. A length of lining material 12, comprising a web or film of heat-shrinkable plastics material, is laid onto the open blank and secured thereto by lines of adhesive 13 disposed on the base 2 of the blank 100, the lines being parallel to the direction of travel of the blank through a liner apparatus for producing blanks having retaining means in accordance with the invention, as described in detail hereinbelow. The lines of adhesive extend from the side wall base fold lines 4,6 towards the central longitudinal axis of the base 2 of the blank 100. The number and position of the adhesive lines 13 is selected according to the use to which the container is to be put.

It will be appreciated by the skilled reader that by applying the glue lines parallel to the direction of travel of a blank through the apparatus applying the liner, the glue may be applied continuously and at high speed. The momentum of the blank as it is processed need not be interrupted. Additionally, by applying the glue in this orientation, the shrink wrapping of articles within the container is enhanced as the film/lines can pull together between the glue lines to give a better grip on the articles contained.

It will also be appreciated by the skilled addressee that although reference is made throughout the present description to glue lines being applied to the blank, it is also feasible to apply an adhesive film to the article retaining web or to utilise alternative means for securing the web to the blank, for example, double-sided adhesive tape.

In the illustrated embodiment, four lines of adhesive are used to fix the central portion of the film to the blank 100. Two flaps 14,15 of the material or film 12 are adapted to be folded over the contents of the container, however, during assembly of the blank and transport thereof, the flaps 14,15 are retained in position by one or more “glue spots” 13a applied to the underside of the lid portions 10,11. Advantageously, the blank can be machine folded to form an open-mouthed container without risk of the film being dislodged or trapped by folding portions during the container forming process or during automated or manually filling the container. Additionally, by using simple glue spots to retain the flaps 14,15 to the lid portions, the flaps can easily be torn away from the lid portions 10,11 when required to cover or overlie the contents of the container. FIG. 2c shows particularly the advantages of using a plurality of glue lines 13 to retain articles 16 within the container formed by the blank 100. The flaps 14,15 are pulled away from the glue spots 13a on the lid portions 10,11 and laid one end over the other. Heat is applied, usually via a hot air stream or within a heat chamber, and the heat-shrinkable material film 12 draws in around the or each article 16. A plurality of tension lines are formed between the article(s) and the adhesive lines 13 to retain the article(s) in place.

As discussed hereinabove, the orientation of the blank and the direction of travel of a blank through a machine is described with respect to the leading and trailing edges 10G, 11G of the blank 100 and the terms “upstream” and “downstream” are defined with respect to the source of materials and the conveying destination, respectively. The fact that materials may be sourced from different physical direction is irrelevant to the above definition.

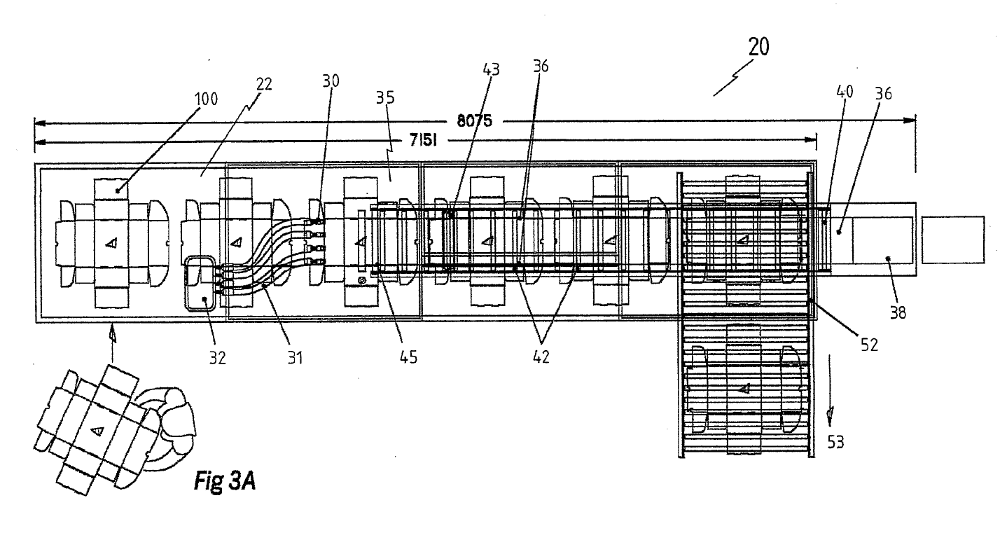

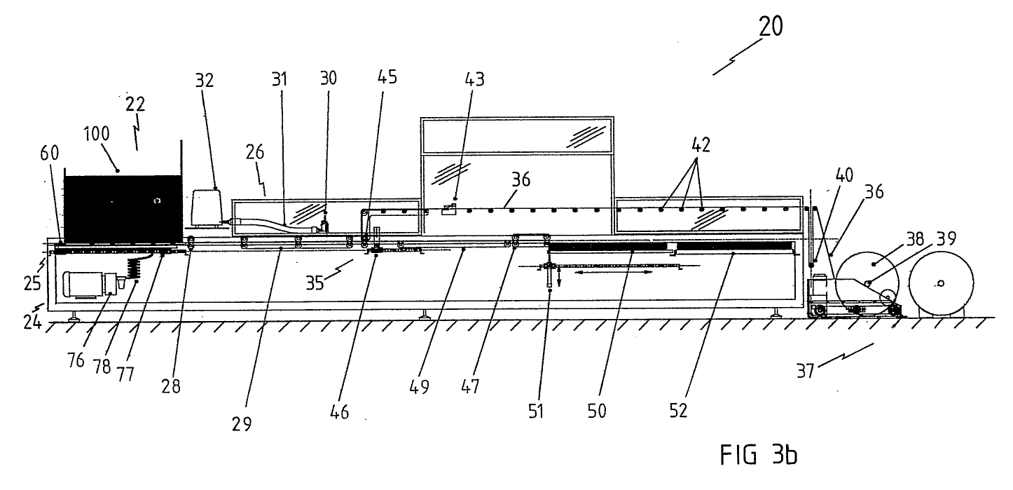

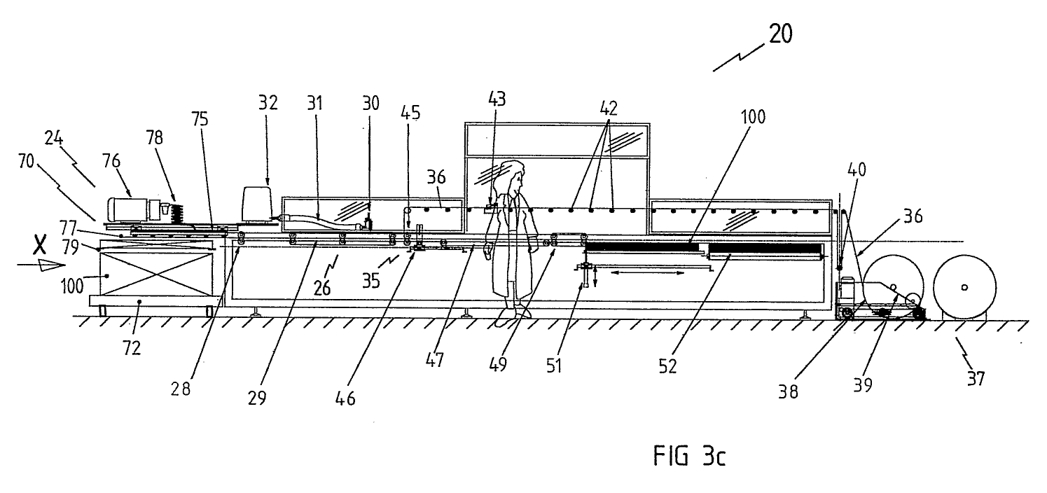

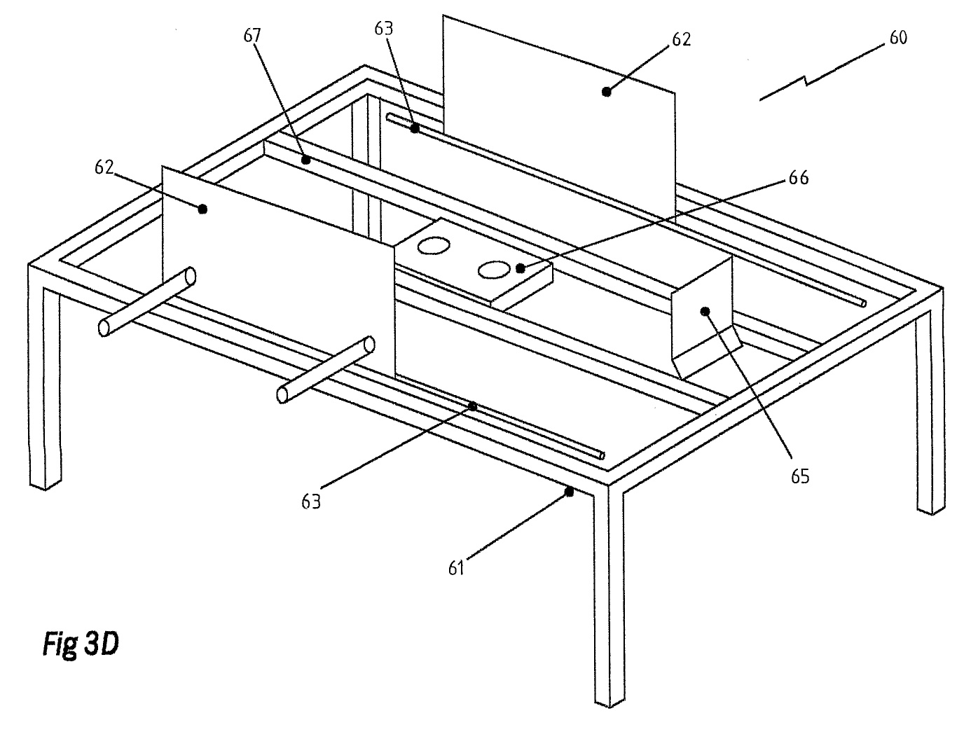

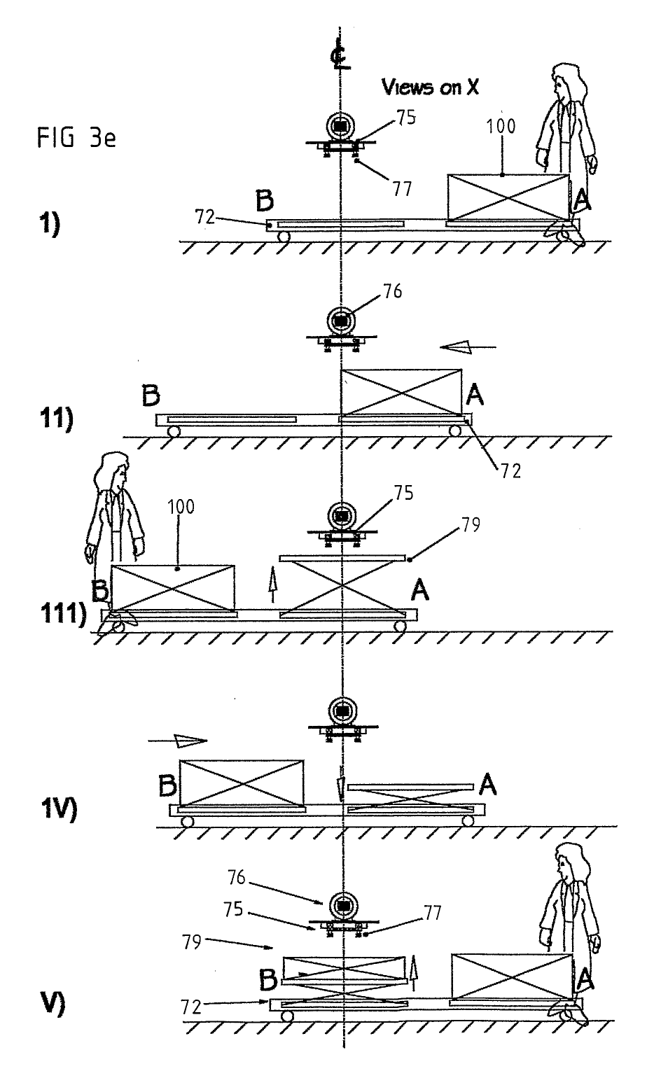

With reference now to FIGS. 3a and 3b, a first arrangement of apparatus 20 for forming blanks of the type having an article retaining means 12 thereon is shown. Simply put, a stack of cut blanks 100 as described hereinabove are passed through the apparatus 20 which applies a sheet of lining material 12 thereto to form the lined blank of the invention. The blank liner apparatus is controlled via a central microprocessor-based controller unit (not shown).

In the illustrated embodiment, the liner apparatus 20 comprises a first arrangement of blank feeding mechanism 22 comprising a magazine adapted to receive plain blanks cut to the required specification. The mechanism, as is described in more detail hereinbelow, is provided at the upstream end of the liner apparatus 20 and includes a vacuum circuit 24 and optionally a mechanical pusher 25 to introduce blanks individually to an adhesive applicator, in this case, a glue application station 26. Gripper or nip rollers 28 are used to guide the blank between top and bottom feed belts 29 which carry the blank past glue applicator guns 30 at which time hot melt glue is selectively applied to the blanks. The hot melt glue is applied by four glue guns 30 fed via heated hoses 31 from a hot melt glue storage tank 32 under microprocessor control. The hot melt adhesive is applied to the blank by a reciprocating compressed air position pump to generate pressure and solenoid operated applicator guns 30 to open the pressure circuit to atmosphere, thereby accurately firing the adhesive onto the board at points controlled by the central control unit in accordance with the requirements determined by the shape and design of the blank 100. The blank is then fed to the liner application station 35 where shrink-wrap material 36 is applied to the blank. The material is fed to the application station 35 from a film drive system 37.

The shrink-wrap material 36 is provided as a film web from a reel 38 mounted for rotation on a gravity axis 39 positioned towards the downstream end of the apparatus. As a first reel 38 of the material is depleted, the gravity axis 39 moves to activate a splicing mechanism of the type well appreciated in the art. An accumulator comprising a dancing arm roller 40 ensures that film is provided to the apparatus during splicing so that an uninterrupted supply is achieved. The film web is fed via a series of support rollers 42 through a non-return gripper 43 to a pressure roller arrangement 45 which adheres the film 36 to the blank 100 and applies pressure to spread the glue between the blank and the liner 12 of film material 36. A film web cutter 46 has a transverse cutter which operates “on the fly” and cuts using a cold blade protected within a slotted anvil.

In an alternative arrangement (not shown), the web material is applied to the blank in two separate sections, whereby at least a central region of the base remains uncovered by the material. In such an arrangement, the operation of the cutter defines the length and position of the web applied to the blank. If required, the base has no web material applied thereto and lengths of web material are adhered only to the end walls.

A transfer conveyor 47 moves the blank with liner 12 towards a pair of speeder pinch belts 49 which accelerate the blank and liner onto a collating table 50. When the table 50 is full, a discharge transfer mechanism 51 moves the accumulated stack of blanks to an ejector table 52, which comprises a conveyor 53 disposed at 900 to the direction of travel of the blanks through the apparatus 20.

FIG. 3c illustrates a second arrangement of apparatus for forming blanks which features an alternative arrangement of blank feeding mechanism 70 but in all other respects is identical to the apparatus of FIGS. 3a and 3b.

FIG. 3d is a perspective elevation of the first arrangement of blank feeding mechanism 60 provided at the upstream end of the lining apparatus 20. The mechanism comprises a support table 61 having a pair of adjustable side plates 62, each having an inwardly facing blank edge engagement portion 63. An end plate 65 is provided to square the stack of blanks into a magazine feed. On the underside of the table 61 an upwardly facing vacuum operated suction cup 66 is provided on a pair of rails 67 along which the cup is free to move. To feed a single blank into the blank lining apparatus 20, the suction cup 66 is brought upwardly into contact with a blank 100 from the base of the stack. The vacuum is switched ON and the cup 66 engages the blank. The cup is then moved downwardly, deflecting the centre of the blank so that the edges thereof are pulled from the blank edge engagement portions of the side plates 62. The individual blank is then presented to the lining apparatus 20 by the movement of the cup 66 along the rails 67. Gripper rollers 28 of the lining apparatus 20 then take the blank as the vacuum to the cup 66 is released. The suction cup assembly then moves back along the rails 67 to its central position, ready to select the next blank.

Referring now to FIGS. 3e(i) to 3e(v), the second arrangement of blank feeding mechanism 70 comprises a pair of lift tables A,B positioned side by side on a wheeled shuttle carrier 72. From start-up, a first lift table A is loaded with a stack of blanks 100 in a first side position. The shuttle carrier 72 is then moved so that the centre of the first table A aligns with a vacuum picker mechanism 75. Individual blanks are fed into the machine using the picker mechanism 75 which comprises a vacuum pump 76 and a picker arm 75 having an array of suction cups 77 thereon. The vacuum is presented at the suction cups 77 via a series of flexible hoses 78 and associated couplings with valves controlled by a sub-controller unit in communication with the central microprocessor controller.

In common with the first arrangement of picker mechanism of FIG. 3d, the vacuum pump 76 is run continuously and the vacuum at the suction cups 77 is switched ON and OFF according to the required action and/or the position of the picker arm with respect to the machine.

When the blanks 100 are in position in the stack or magazine, the picker arm 75 moves to engage the upper surface of the top blank in the stack. When the arm engages the stack the vacuum is switched to the suction cups which grip the blank. A pressure differential switch in the vacuum circuit will register whether the cups have obtained an adequate grip to lift the board from the stack. The picker arm 75 is then moved back to a central position with the blank and subsequently is extended to carry the blank in a downstream direction, placing the leading edge 10G of the blank 100 between a pair of rotating nip rollers 28 which carry the blank into the lining apparatus 20.

At the instant the nip rollers 28 grip the blank and commence feeding it into the lining apparatus, a valve switches to remove the vacuum pressure from the suction cups 77 thereby releasing the board. The picker arm 75 then returns towards the central position until the trailing edge 11G of the blank passes a sensor which via the controller signals the picker arm 75 to engage another blank from the stack. The next blank is fed to the nip rollers 28 as before with a relatively small gap (say 50 mm) between the trailing edge 11G of one blank and the leading edge 10G of the subsequent blank.

As the stack is depleted, the first lift table A elevates to supply a continuous feed of blanks to the picker arm. As the table reaches its upper lift limit with a predetermined number of boards (say 30) left in the stack, a support mechanism comprising edge support plates 79 moves under the remaining blanks and the first lift table A is withdrawn. At this time, a second lift table B has been fully loaded with blanks and is ready to replace the position occupied by the first table A.

Provided confirmation is received that the second table B is loaded, the shuttle carrier 72 is signalled to move the second table B towards the central position to align with the picker mechanism 75 as the first table A is lowered and is made ready to receive a subsequent load of blanks. During this procedure, the picker arm 75 continues to take blanks from the support mechanism plates 79. When the stack on the second table B is aligned with the picker mechanism 75, the blanks remaining on the support plates are dropped onto the top of the stack as the support plates are withdrawn. This stack is then raised by the lift table B so that the uppermost blank is in the appropriate position to be engaged by the picker arm. The support plates 79 again engage the underside edges of the last blank remaining in the stack when the level reaches a preset amount. This means the machine can be run continuously without stoppage to maximise productivity rates.

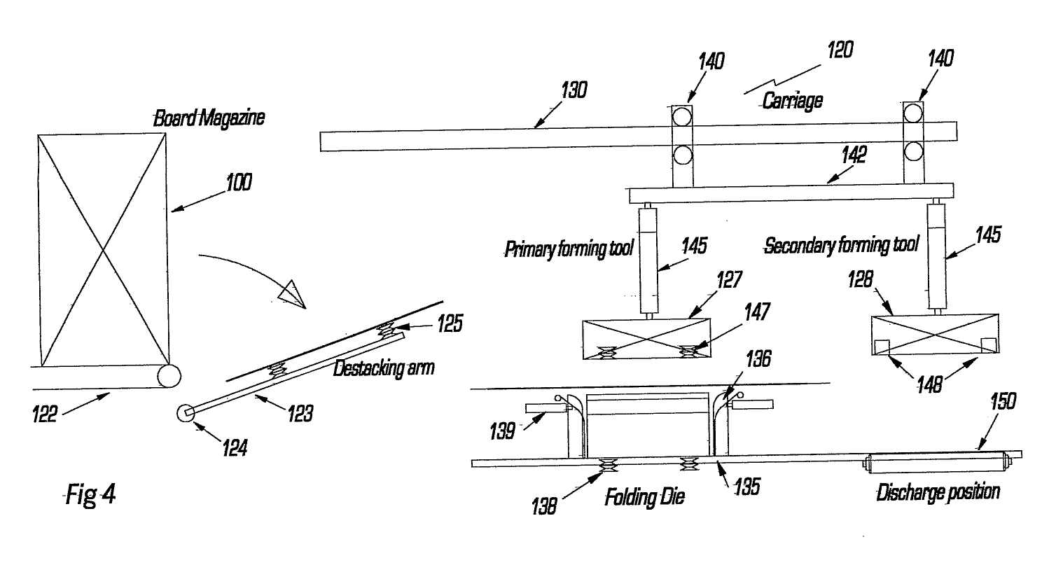

FIG. 4 is an overview of a container forming apparatus 120 in which a magazine of lined container blanks 100 are stacked vertically on a conveyor 122. A destacking arm 123, mounted for rotation about a pivot 124, includes suction cups 125 for selecting individual blanks from the front of the magazine to present said blanks to container forming tools 127,128 movable along a carriage arm 130. The container forming apparatus 120 includes a vacuum circuit, elements of which will be described in more detail hereinafter, which is powered via a continuously operated pump and switched to and from air cylinders and suction cups via valves operated under microprocessor control.

The container forming apparatus 120 further includes a static folding die 135 having peripheral edge portions 136 adapted to deflect elements of a container blank sequentially to facilitate the formation of a container in conjunction with the forming tools 127,128. The folding die 135 includes suction cups 138 to engage the base 2 of a container being formed so that the container is not inadvertently withdrawn from the die 135 with the primary forming tool 127 when it is retracted. Air cylinders 139 are positioned on opposite sides of the folding die to urge elements of the container blank to urge elements of the container blanks inwardly so that they may be engaged during the downward stroke of one of the forming tools 127,128. The carriage arm 130 provides a rail along which the primary and secondary forming tools 127,129 move. Wheeled coupling arrangements 140 are attached to a tool carrying support member 142 to which the forming tools 127,128 are secured a fixed distance apart. The tools are fixed to the support member 142 by telescopic cylinders 145 which are pneumatically operated in this embodiment. The primary forming tool 127 includes blank engaging suction cups 147 attached to the vacuum circuit via the support member 142 which also conveys pneumatic power to the telescopic cylinders 145 and to air cylinder 148 provided within the secondary forming tool 128. Adjacent the folding die 135, and spaced therefrom a distance equal to the distance separating the primary and secondary forming tools, 127,128, there is provided a discharge conveyor 150 for transporting open-mouthed containers to a filling station or to storage.

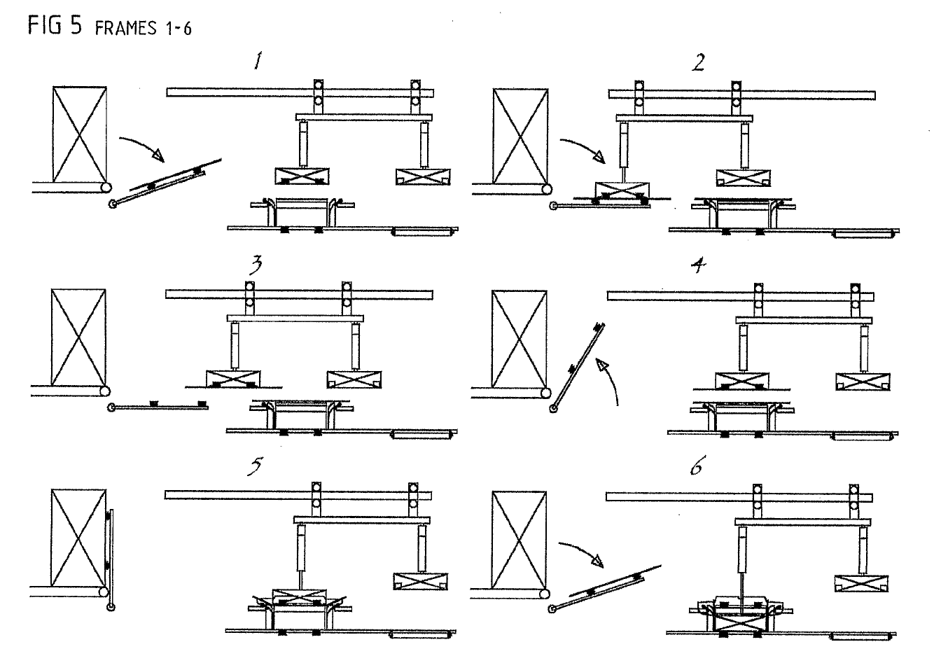

Each step of the container forming process, as illustrated in the twelve vignettes or frames making up FIG. 5, will now be described. The destacking arm 123 includes a series of suction cups 125 which attach to the front (unlined) surface of the leading one of a magazine loaded with lined container blanks 100. The front surface of the blank once folded becomes the outer surface of the container thus formed. The magazine has a predetermined capacity but operationally is replenished to provide a continuous supply of vertically stacked blanks to the destacking arm 123.

The sequence is shown at the start of a production run with no containers in the process of being formed. In Frame 1, a first blank is selected by the destacking arm 123 when the arm moves from a horizontal rest position about its pivot 124 to the front surface of the leading board in the magazine. A vacuum is switched to the suction cups 125 which engage the blank and separate it from the magazine stack. The blank is carried with the arm as it pivots towards its horizontal rest position. In Frame 2, the primary and secondary forming tools 127,128 move together on the support member 142 as it is driven along the carriage arm 130 and the primary forming tool 127 is lowered to abut the now horizontal blank. as supported by the destacking arm. The suction cups 147 on the base of the primary forming tool 127 engage the inner lined side of the blank at the base 2 and the vacuum is switched OFF at the destacking arm suction cups 125 and ON at the tool suction cups 147. As illustrated by Frame 4, the blank is then lifted by the primary forming tool suction cups 147 and the support member 142 moves the primary forming tool 127 towards a precise position over the container folding die 135. At the same time, the destacking arm 123 rotates about the pivot 124 from its horizontal rest position towards the new leading (second) blank in the magazine. As the blank is engaged by the suction cups 125 of the destacking arm, as illustrated in Frame 5, the primary forming tool 127 lowers the first blank towards the folding die 135 and “stuffs” the blank into the die.

As the blank is “stuffed” into the die, the following folding actions occur:

the side wall tuck-in flaps 4C,6C are deflected to a substantially vertical position;

the longer side wall base fold lines 4,6 are deflected substantially vertically, which has the effect of moving the tuck-in flaps 4C,6C into position adjacent the shorter end wall base fold lines 3,5; and

the end wall base fold lines 3, 5 are deflected, hereby forming an open-mouthed cuboid shape.

In Frame 6, the cuboid shape is retained in the folding die 135 by the suction cups 138 disposed in the bottom of the die and the primary forming tool 127 is then withdrawn from the cuboid as the vacuum to the forming tool suction cups 147 is removed. As the tool is withdrawn, the subsequent blank is taken from the magazine by the destacking arm 123, as described above.

When the new blank is in a horizontal position, as shown in Frame 7, the support member 142 is moved along the carriage arm 130 so that the primary forming tool 127 is disposed over the region of the blank due to form the base 2 of the next container and the secondary forming tool 128 is disposed over the folding die 135 containing the open-mouthed cuboid shape of the preceding blank. At this stage, the folding die air cylinders 139 (one pair on each side) push pistons to fold the tuck-in flap positions of each end wall 3B,5B over the lighter riser fold lines 3A,5A (thereby ensuring that the fold occurs at the riser fold lines 3A,5A in advance of any folding along the over-tab fold lines 3D,5D). The pistons retain the flap portions 7 in a substantially horizontal position. It should be noted that the pistons are disposed towards the edges of the flap portions 7 so as not to impede the secondary forming tool 128 when it descends into the folding die.

Frame 8 shows the primary forming tool engaging the subsequent blank, as supported by the destacking arm, as the secondary forming tool is forced into the folding die. In this sequence, the secondary forming tool 128 folds the tuck-in flap portions 7 into the open-mouthed cuboid shape of the container and the air cylinders 148 within the secondary forming tool 128 include pistons which force the tuck-in flap positions 7 against the side wall tuck-in flaps 4C,6C. This pushes the short rectangular extensions 7A,7B of each flap portion 7 into the corresponding receiver slots 8A,8B disposed in the base 2 immediately adjacent the end wall base fold lines 3,5.

The pistons of the air cylinders 148 within the secondary forming tool 128 include spikes at their free ends so that by engaging the material of the newly formed open-mouthed container, the container is withdrawn from the folding die when the secondary forming tool 128 is retracted therefrom, as illustrated in Frame 9. This action occurs concurrently with the lifting of the subsequent blank from the destacking arm 123 by the primary forming tool 127.

In Frame 10 the destacking arm 123 again rotates towards the leading blanked in the magazine as the forming tool support member 142 moves the primary forming tool with the subsequent blank and the secondary forming tool with the open-mouthed container over the folding die 135 and the discharge conveyor 150, respectively. This step is essentially the fully-loaded view of the apparatus as shown earlier (in Frame 4).

Again, as the destacking arm 123 engages the leading blank in the magazine, the primary forming tool “stuffs” a blank into the folding die 135, commencing the folding step as before, and, as shown in Frame 11, the secondary forming tool 127 places the open-mouthed container onto the discharge conveyor 150. The pistons of the air cylinders 148 within the secondary forming tool 128 are withdrawn so that the spikes at the ends thereof disengage the material of the container. As the stuffing and folding of the subsequent container takes place, a new blank is grabbed by the suction cups 125 of the destacking arm 123. When the destacking arm carries the new blank towards the horizontal rest position, as shown in Frame 12, the primary and secondary tools are withdrawn from their respective partially formed and fully formed open-mouthed containers.

The containers thus formed are conveyed by the discharge conveyor 150 either to storage or, more conveniently, to a filling and sealing machine. The lid portions 10,11 remain standing substantially vertically throughout the forming process after the blank has been “stuffed” into the folding die. The tuck-in flaps 10B,11B protrude sidewardly from the first and second lid portions 10,11 as the container is discharged from the apparatus.

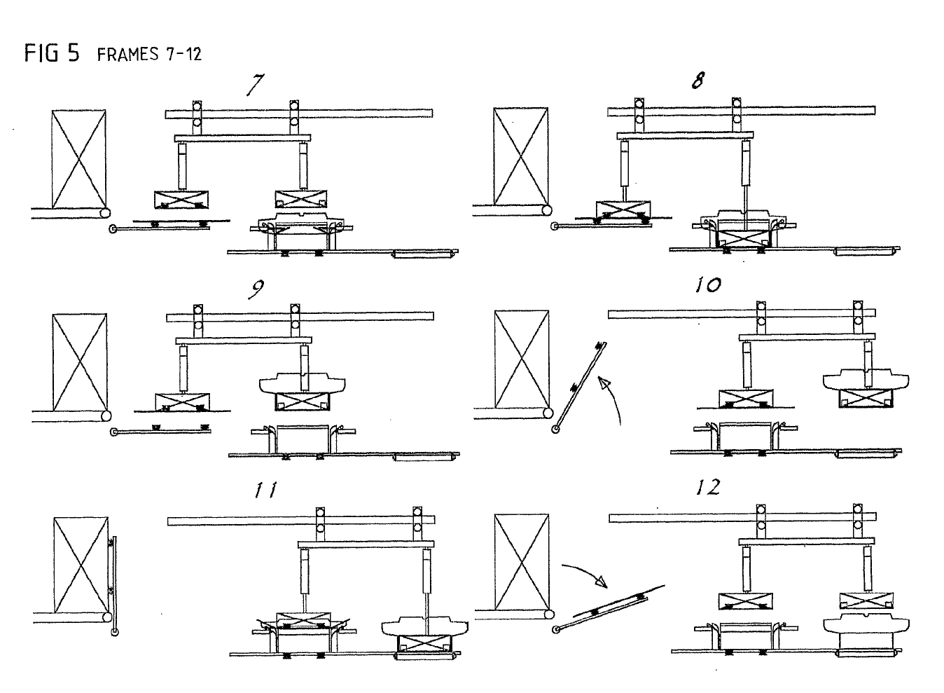

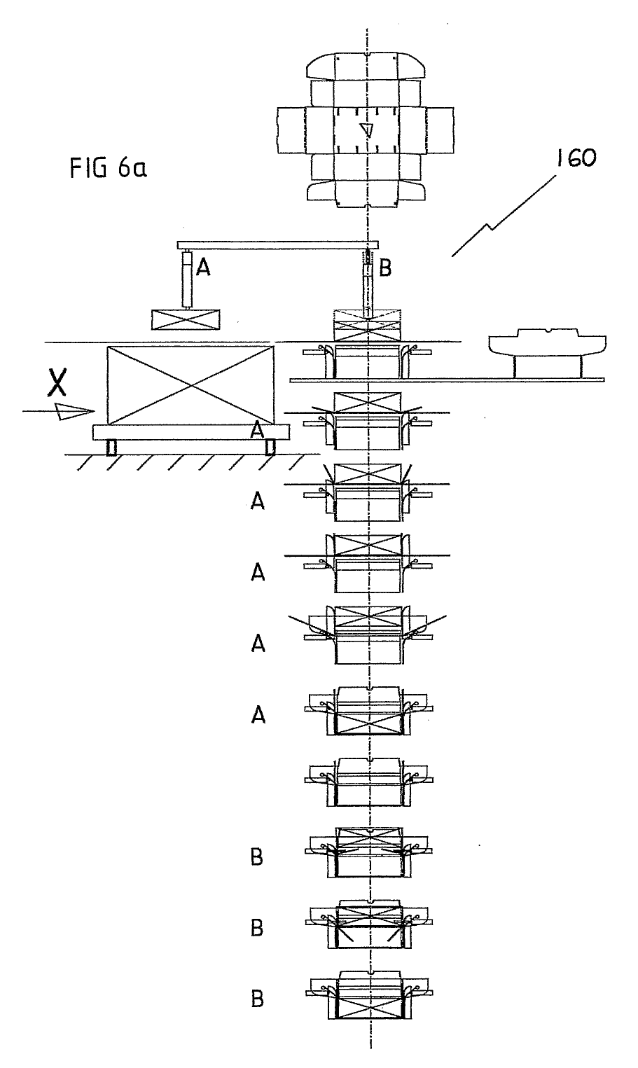

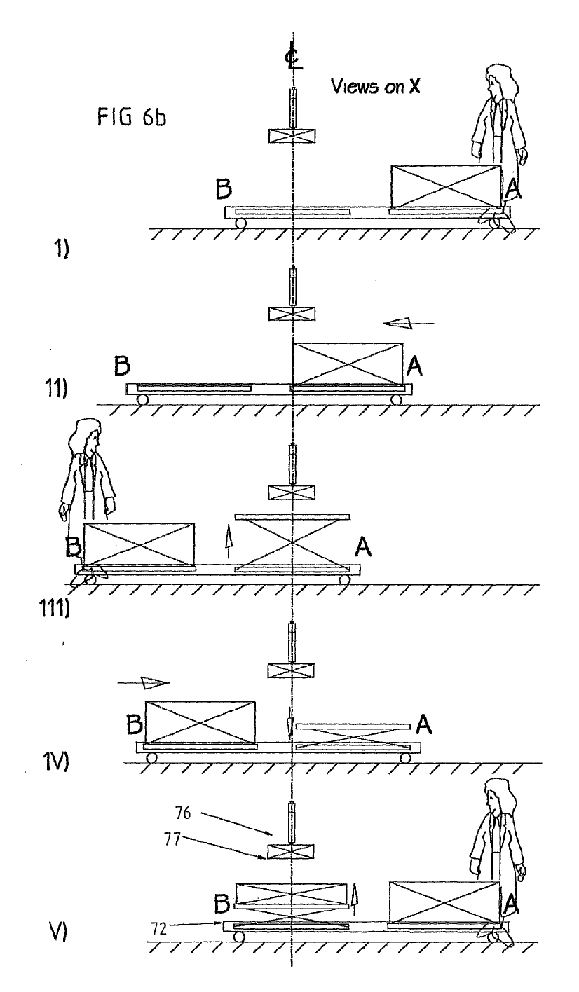

Referring now to FIGS. 6a and 6b, an alternative arrangement of container forming apparatus 160 is shown. As in FIG. 4, the forming apparatus 160 includes a static folding die 135 and primary and secondary forming tools 127,128 for engagement therewith. The forming tools are spaced apart on a support member 142 moveable along a carriage arm 130 and moveable vertically by means of telescopic cylinders 145, as before. In this arrangement, the magazine for feeding lined blanks 100 to the forming apparatus comprises a stack of blanks mounted on support tables A,B, similar to the arrangement described in detail in FIGS. 3e(i) to 3e(v). As the operation and loading of the tables is so similar to that previously described, no further detail appears necessary here. As shown in FIGS. 4 and 5, the sequential steps to forming a container are unchanged with the omission of the destacking arm thereof.

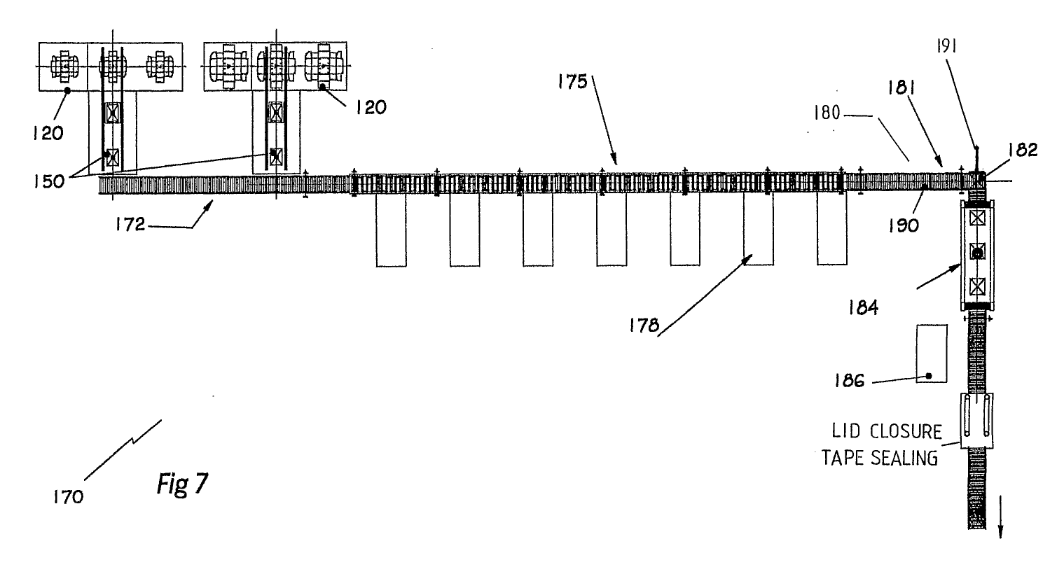

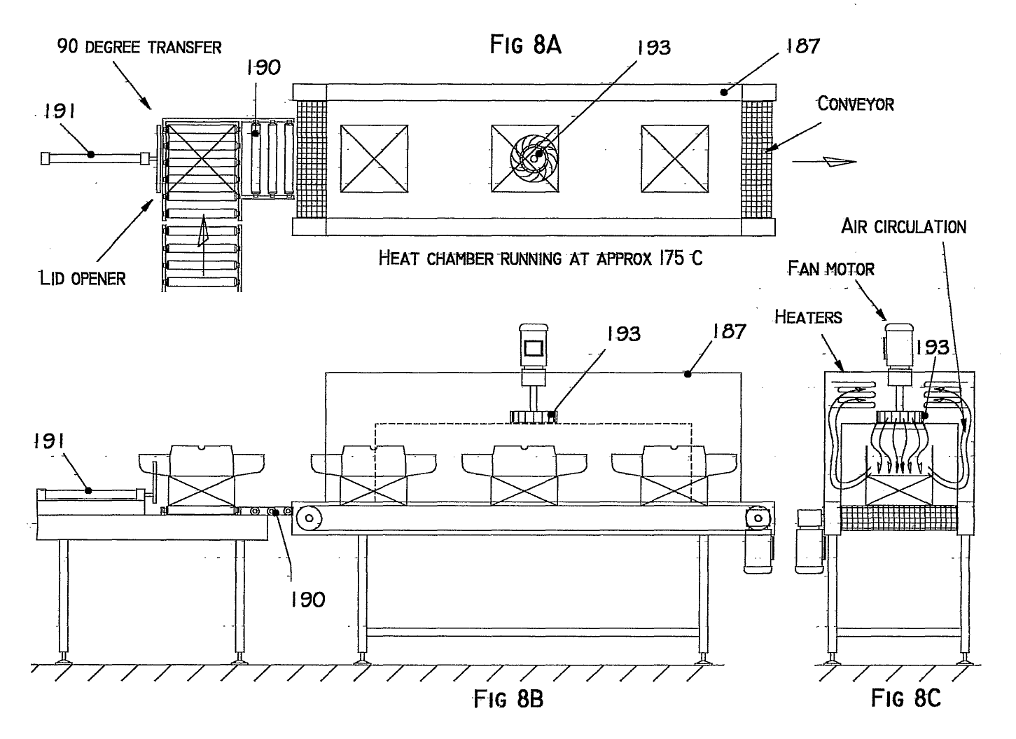

FIG. 7 illustrates a filling and closing station 170 for containers of the type disclosed herein. In the illustrated embodiment, tow container forming apparatus 120 are the first forming a smaller size container relative to the larger container formed by the second apparatus. The open-mouthed containers are fed from their respective discharge conveyors 150 to a buffer conveyor 172 which in turn places containers in a two level accumulator 175 adjacent a plurality of packing tables 178. The containers are manually removed from the accumulator 175 and packed with the contents and the flaps 14,15 of the liner material 12 are torn from the glue spots 13a attaching them to the lid portions 10,11 to be laid over one another over the contents 16 of the container. A label indicating the destination of the contents is then adhered to a side wall or a lid portion of the container and the filled container is placed onto a discharge conveyor disposed beneath the accumulator 175. The discharge conveyor includes a zoned region 180 terminated with a drop gate 181. Containers are metered through the gage 181 to a transfer zone 182 from which they are fed through a “shrink tunnel” 184 comprising a heating chamber as detailed hereinbelow with reference to FIGS. 8a to 8c. Heat applied to the exposed liner material 12 overlying the contents 16 of the container causes the material 12 to shrink around the contents 16 creating the tension lines 17 in the material as referred to in FIG. 2c. The contents are now restrained within the container which is passed through a visual inspection station 186 for lid closure. sealing and dispatch.

Ideally, lid closure and sealing is automated using well established techniques., including taping, for example.

Referring now to FIGS. 8a to 8c, a heat chamber 187 of the “shrink tunnel” 184 is shown. As discussed above, the zoned region 180 of the discharge conveyor includes a drop gate 181 which is moved by a lid opener mechanism. A container passed through the gate 181 is fed onto a further conveyor 190 by a pusher mechanism 191 to effect a 90° transfer onto said conveyor 190 which transports the open-mouthed container and contents through the heat chamber 187. A fan 193 blows heated air directly down into the container and expelled air is recirculated back towards the fan 193 for reheating. The heat chamber 187 runs at approximately 175C with low dwell time to ensure no damage to the contents for dispatch.

It will be appreciated by the skilled addressee that the shrink-wrappable web material web may be substitute by different materials which can be bonded together to secure the contents of the container therein. Materials having selectively applied adhesives or materials having characteristics which enable the free ends thereof to adhere to one another with sufficient strength to achieve the desired results (including in a manner al-in to so-called “cling-films”) may also be used. Such material may be used to obviate the heat chamber, thereby reducing the overall size and energy requirements of a packaging plant or facilitating packaging of customers purchases or articles for dispatch at a retail outlet.

Suggested alternatives include an adhesive coated material web having either a lining material applied to the adhesive coated side of the web or a release coat applied to the opposite side thereof. In a further development of the invention, the article retaining web comprises a material adapted to adhere substantially exclusively to itself. Such material is provided with a liner applied to one side (to prevent it sticking to itself in a reel) but can be handled by standard non-coated machine feeders, rollers and other components and stock. When used with a container of the invention, at the article packaging stage, the liner is removed (normally from the entire length of web material) and the articles are placed into the container and onto the newly exposed surface of the material web. The articles will not adhere to the material, however, when the ends of the material are brought together, they stick firmly to one another. The material web ends may then be manually “scrunched” together to apply adhesive pressure to the web but more particularly to provide tension in the web to retain the articles securely in the container during transit.

Material web as described above is exemplified by the material webs or films available from Milprint, Inc. (Oshkosh, Wis. 54904, United States of America).

It will be appreciated by the skilled addressee that machine forming of the blank facilitates fast and efficient forming of the open-mouthed containers for subsequent reception of materials. It will be further appreciated that by adapting the magazine, the folding tools and the folding die, other blanks which have been modified for machine folding may also be considered.

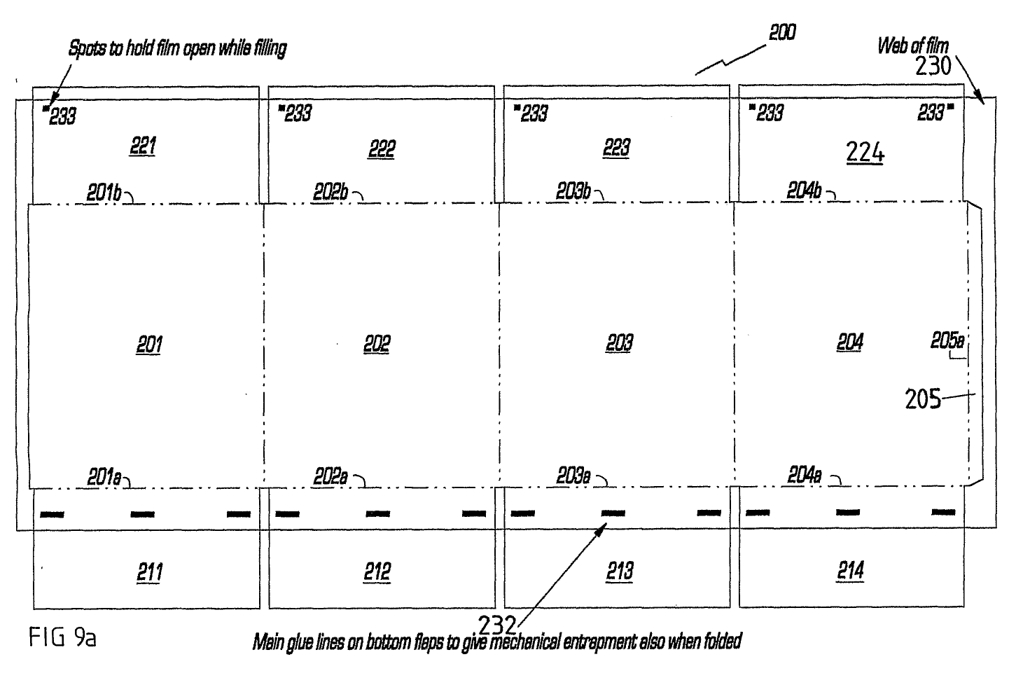

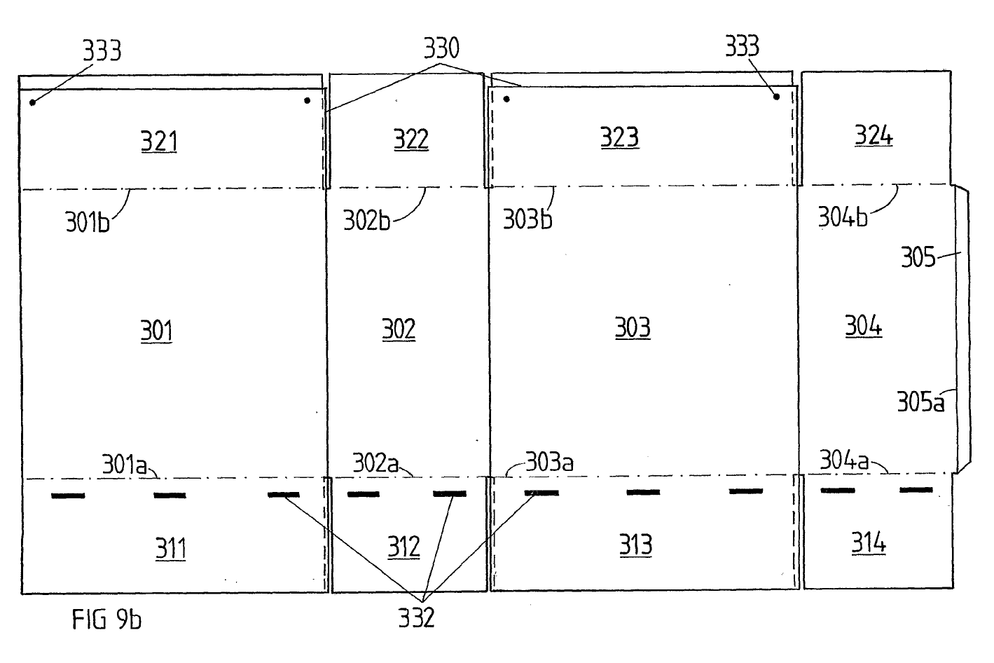

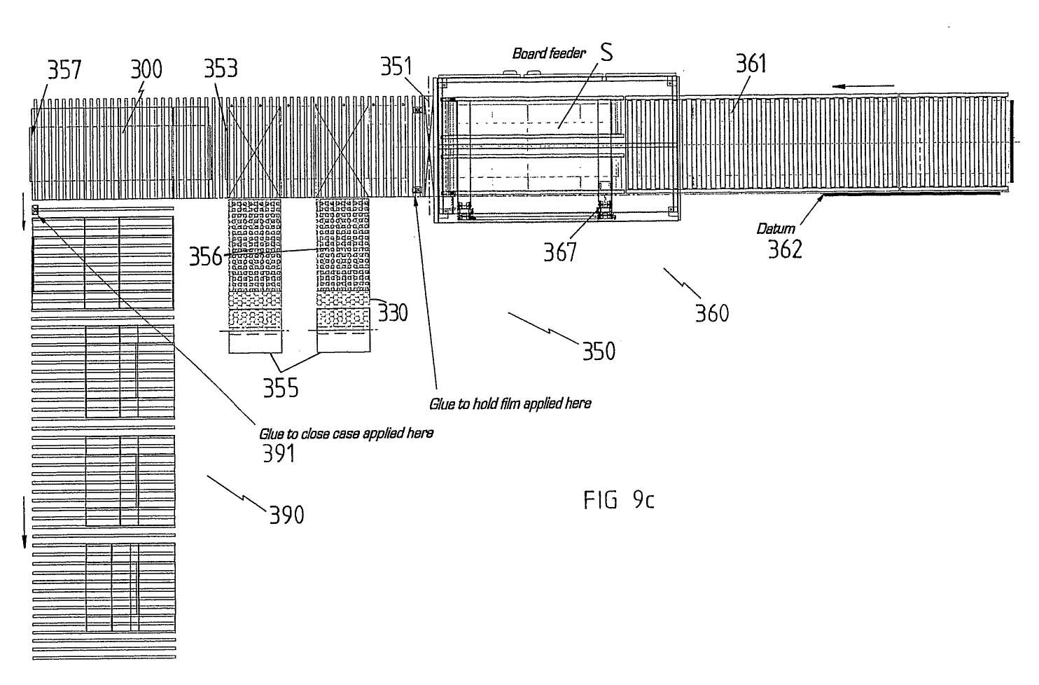

For example and with reference to FIGS. 9a and 9b, there is shown two arrangements of a second embodiment of container or container blank formed from substantially standard blank stock of the well-known RSC type container and similar type containers which are modified to include an article retaining film or web thereon. The first arrangement of container blank 200, as illustrated in FIG. 9a, has four side walls 201,202,203,204 and a securing flap 205, which is normally folded around fold line 205a from the final side wall 204 to inside the first side wall 201 and glued or stapled thereto. Base portions 211,212,213,214 are attached to their respective side walls via fold lines 201A,202A,203A,204A and lid or top portions 221,222,223,224 are attached to their respective side walls via further fold lines 201B,202B,203B,204B. The RSC style container blank 200 includes a web or film 230 which extends at least over the side walls 201,202,203,204, over at least a portion of the base portions 211,212,213,214 and over substantially all of the lid portions 221,222,223,224. The web or film 230 is adhered to the base portions by glue lines 232 positioned so as to ensure mechanical entrapment of the web 230 when the base portions 211,212,213,214 of the container are folded. Glue spots 233 are provided to adhere the web 230 to the top or lid portions to prevent the web falling into the container during formation and during conveying or loading. Additionally, the glue spots 233 prevent the web 230 from becoming entangled in the container forming apparatus. Before the container is closed, the web is mechanically separated from the lid positions to overlie the contents of the container. Where the web 230 is a heat-shrinkable film, heat is applied directly or indirectly to the web to shrink-wrap the contents in place to attenuate potentially damaging movement of the contents during freight or further conveying, for example.

It will be appreciated that the first arrangement of RSC style or like container blank is formed using substantially the same techniques and apparatus (once modified to accommodate the blank stock) as used for the first embodiment of container blank 100 described hereinabove. Where the RSC style container differs is in forming the container from the blank. Thus, there is provided a method of forming a RSC type container from the container blank 200 of FIG. 9a.

Accordingly a second arrangement of container blank 300, exemplified here in FIG. 9b by a standard RSC type container blank to which lengths of a material web have been applied. The container blank comprises four side walls 301,302,303,304 and a securing flap 305, which is normally folded around fold line 305a from the final side wall 304 inside the first side wall 301 and glued or stapled thereto. Base portions 311,312,313,314 are attached to their respective side walls via fold lines 301A,302A,303A,304A and lid or top portions 321,322,323,324 are attached to their respective side walls via further fold lines 301B,302B,303B,304B. The container blank 300 includes first and second lengths of article retaining material web or film 330 extending over two side walls 301,303, over at least a portion of the respective base portions 311,313 and lid portions 321,323. In the illustrated embodiment, the entire area of the relevant base portions 311,313 are covered, as will be explained with reference to the apparatus for and method of forming container blanks described hereinbelow. The lengths of web or film 330 are adhered to the base portions by glue lines 332 positioned so as to ensure mechanical entrapment of the web 330 when the base portions 311,312,313,314 are folded. Glue spots 333 are provided to adhere the web 330 to the top or lid portions to prevent the web falling into the container during formation and during conveying or loading. Additionally, the glue spots 333 prevent the web 330 from becoming entangled in the container forming apparatus. Before the container is closed, the web is mechanically separated from the lid positions to overlie the contents of the container.

Although reference is made to glue lines and spots being disposed in particular locations and orientations, the invention should not be so limited. Similarly, it will be appreciated that other adhesive means, including double-sided adhesive tape may also be used.

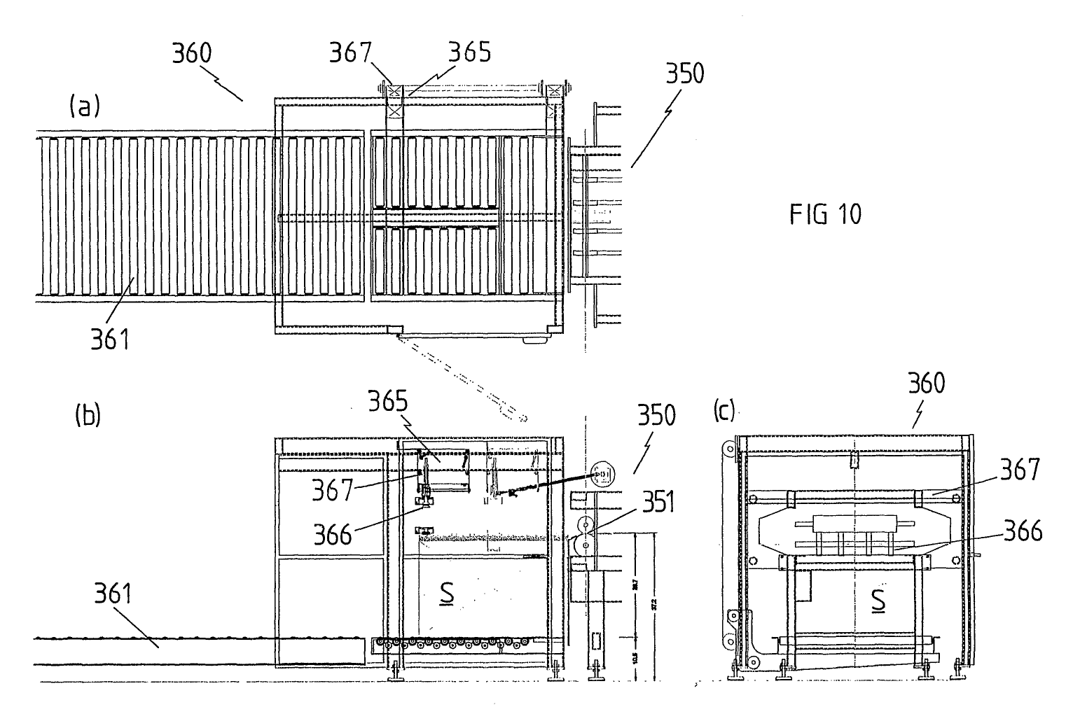

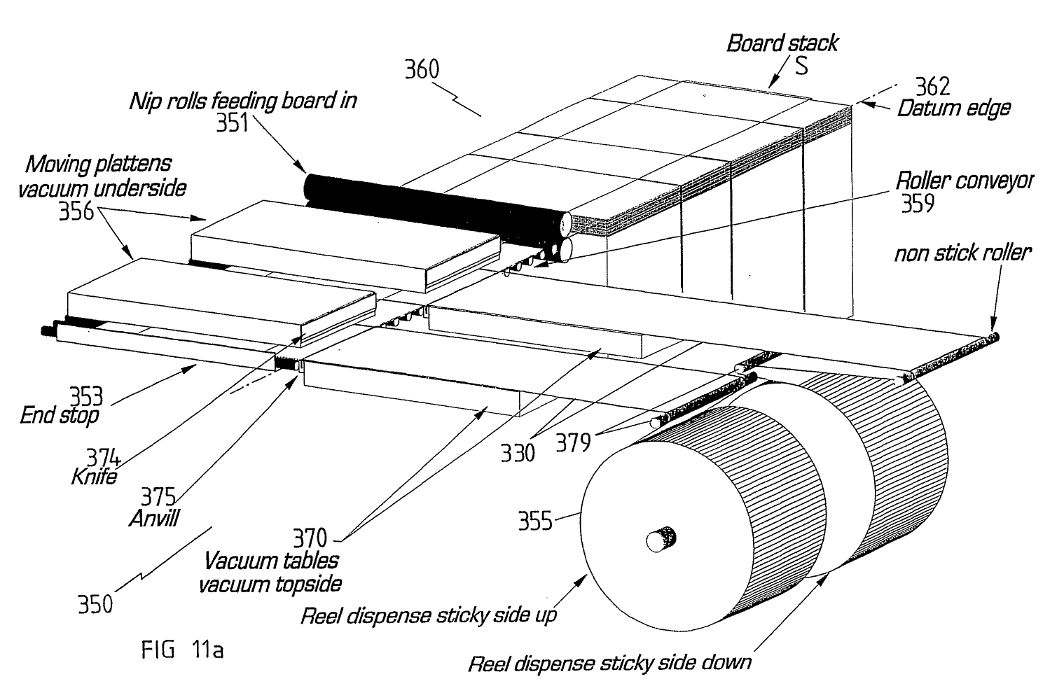

With reference now to FIG. 9c, an apparatus 350 for forming container blanks 300 of the type shown in FIG. 9b having an article retaining web 330 thereon is shown. A stack of pre-formed blank stock S is introduced to a blank feeding mechanism 360, which is described in more detail with reference to FIGS. 10a to 10c, and the apparatus 350 applies sheets of the web material 330 to the blank stock to form the lined blank 300 of the invention. The lined blanks 300 are then transferred to a discharge conveyor to be dispatched for storage or to be introduced to further processing stations where additional steps are conducted, such as forming into an intermediate container stage or folded for storage. In the illustrated arrangement, the discharge conveyor 390 includes an adhesive applicator 391 and folding and forming stages. The lined container blanks 300 are then discharged to an accumulated stack of said blanks.

In this arrangement, the liner apparatus 350 is fed successive blanks from the blank feed mechanism 360 which is positioned to introduce blank stock S to gripper or nip rollers 351 which feed a board past an adhesive application station 352 along a support conveyor to an end stop 353 which locates the board blank at a lining or film application station. At the adhesive application station 352, hot melt glue is selectively applied by a pair of glue guns. In an unillustrated arrangement, a pair of adhesive tape dispensers is provided. When the board blank is located, optionally also by means of a pusher mechanism to position the board against a datum stop, the web material 330 is drawn from a pair of reels 355 by a pair of vacuum platens 356. When the lengths of web material have been placed onto the board blank, a knife cuts the material and the lined blank 300 is fed to a conveyor end stop 357. The blank is then pushed laterally by a pusher mechanism onto the discharge conveyor 390, optionally past another glue applicator gun 391 or to a folding station stapling mechanism or each of the above.

The independent blank stock feeding mechanism 360, as illustrated in FIGS. 10a to 10c, is provided at the upstream end of the lining apparatus 350. The mechanism comprises a feed conveyor 361 onto which a stack of blank stock is positioned against a datum surface 362 (shown in FIG. 9c). The stack is then conveyed to a support arrangement where a picker mechanism 365 feeds individual ones of the blanks towards the nip rollers 351 of the liner apparatus 350. The picker mechanism 365 includes a vacuum operated series of suction cups 366 mounted on a moving carriage 367 and operates by engaging the suction cups 366 to the trailing edge region of a board blank and lifting it sufficiently to break any suction between the selected uppermost board blank and the succeeding one below. The carriage then moves the selected board in the processing direction and feeds the leading edge of the board blank between the nip rollers 351. The vacuum is released from the suction cups 366 and the carriage returns to its initial position to repeat the cycle for the succeeding board. As the suction cups engage only the trailing edge region of the blank and the leading edge is quickly introduced to the nip rollers, there is sufficient time for any suction or surface effect between successive board blanks to be released, minimising multiple blanks being fed to the nip rollers at high speed and thereby reducing the incidence of error or downtime.

It will be appreciated that the blank feeding mechanisms 22, 24 and associated equipment 60, as described hereinabove with reference to FIGS. 3a to 3e, may be adapted for use with the lining apparatus of FIG. 9c.

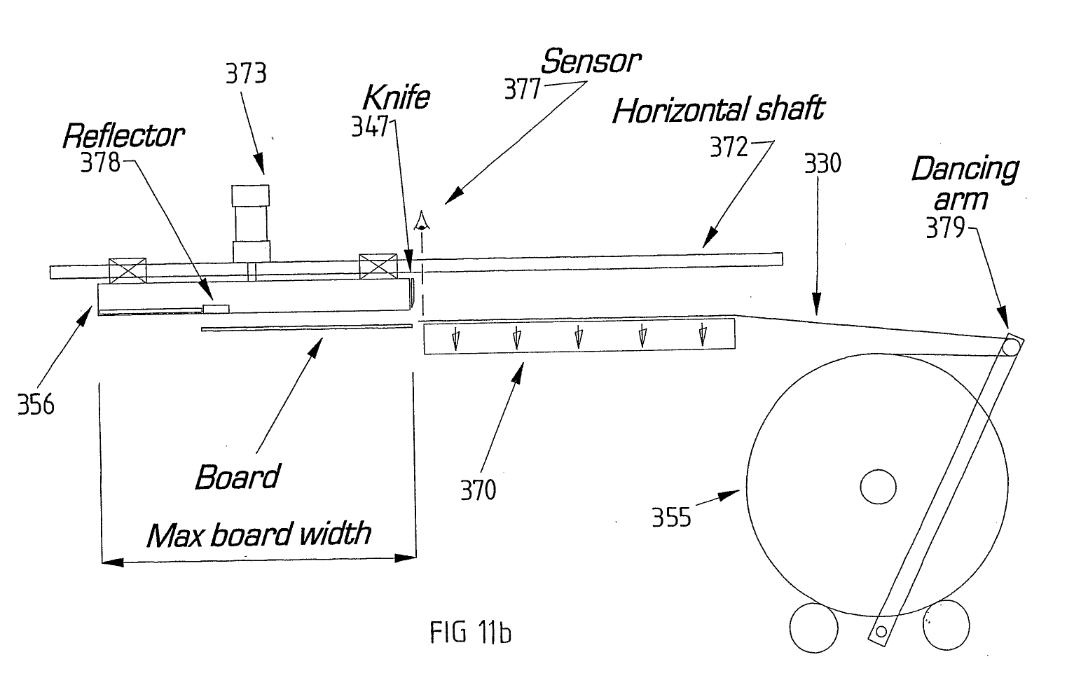

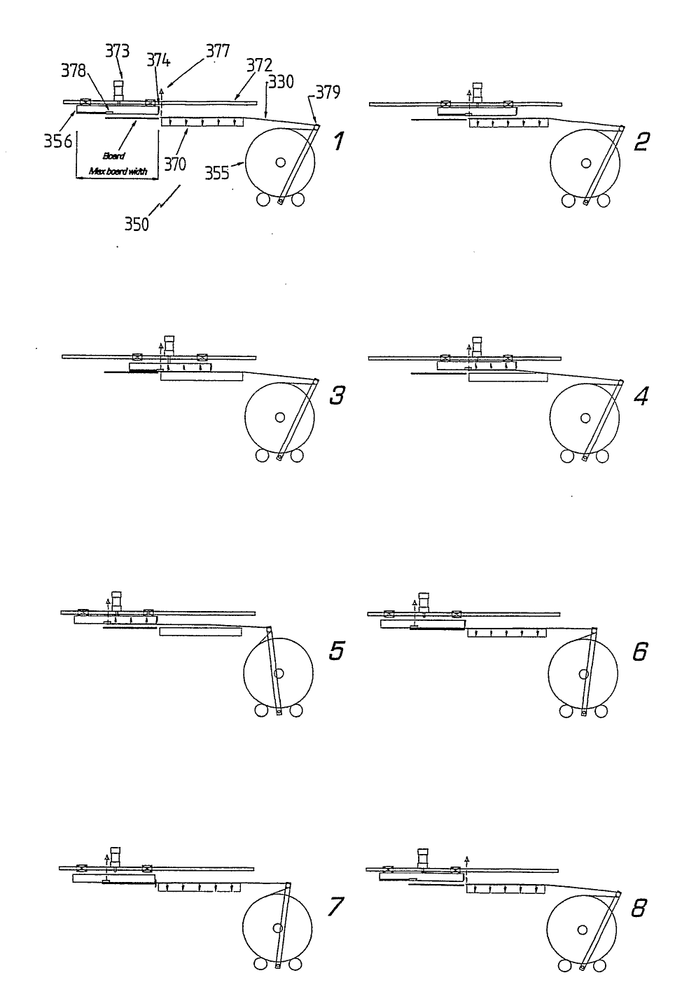

Referring now to FIGS. 11a and 11b, the lining apparatus 350 of the invention includes a lining station where a board is located against the end stop 353 on a support conveyor 359. A pair of vacuum tables 370 are provided to retain in position the article retaining film or lining material 330 which has been drawn from the reels 355. The vacuum platens 356 are movable along a horizontal carriage shaft 372 so that the platens can move over the vacuum tables 370 to grip the material web 330 and convey it towards the blank. When the platens are in position over the tables, the vacuum is switched ON in the platens and OFF in the tables so that the web is now securely held by the platens. The platens then moose along the or each shaft 372, drawing the web material over the board blank and drawing further material from the reels 355 onto the vacuum tables. When the appropriate length of material has been drawn, each vacuum platen is pressed down against the board by an actuation 373 so the web adheres to the board. A knife 374 which is disposed on the trailing edge of each platen 356 operationally drops into a slotted anvil 375 located adjacent to the conveyor 359 to cut the required length of material. At the same time the vacuum on the tables 370 is switched ON to secured the new film material drawn thereon. The vacuum in each platen 356 is then switched OFF and the platens move back to their positions overlying the vacuum tables. As the platens release the lined board, the end stop 353 drops to allow the lined container blank 300 to be conveyed towards the conveyor end stop 357. At least one sensor 377 and reflector 378 is used to verify the position of the component parts to a microprocessor control unit. It will be noted in FIG. 11a that the material reels 355 and dancing arm 379 arrangements are differently configured and this is to allow for dispensing web material having an exposed adhesive coating where one reel feeds the web with the adhesive coating facing upwardly and the other reel feeds the web with the adhesive coating disposed downwardly. This is particularly useful when using a linerless web material having an adhesive coating on one side and a release coating on the opposite side of a web, particularly when utilising an adhesive material adapted to adhere only to itself.

Each of the vacuum platens 356 and tables 370 comprise an array of apertures through which the vacuum is applied. The array includes switchable sections so that the vacuum may be selectively applied. This arrangement allows the platens and the tables to be configured for different widths of material web and different lengths of material to be applied to the board. In this way, a range of sizes and configurations of lined container blank may be formed. A simpler and less expensive alternative is to provide masks to cover over the non-applicable areas of the tables and platens. It will be appreciated that the maximum width of board that can be handled is determined by the width of the support conveyor 359 and the length of the web material to be applied thereto. The length of web material or film applied to the board is determined by the length of the vacuum platens 356. It will be noted that each assembly comprising reel holder and dancing arm 379, vacuum platen 356, table 370, carriage 372 and actuator 373 is independent of the other and this facilitates their relative movement for using the apparatus with different material web and board sizes. The assemblies may be mounted on rails and each one may be removed independently for service and/or repair.

Each step of the lined container blank forming process, as illustrated in the eight vignettes or frames making up FIG. 12, will now be described. Initially at set-up, material web or film 330 is manually drawn onto each vacuum table 370, the vacuum is switched ON to hold the web in place and it is trimmed square across its width by the knife 374 or at the knife position. A board blank is introduced to the nip rollers 351 from a board stack S and is conveyed to engage the stop 353. A side pusher (not illustrated) may pass between the rollers of the support conveyor 359 to position the board for lining with the web material. Adhesive is applied to the board as it passes through the nip rollers.

The sequence is shown at the start of a production run with no container blanks in the process of being lined. For clarity only, one platen, table and material web is shown. In Frame 1, a board blank is in the exact position for film placement with the edge of the board aligned with the cutting path of the knife 374. As the board is introduced to its exact positioning, the vacuum platen is conveyed along its carriage shaft 372 to overlie a portion of the vacuum table 356 to which the film is held, as shown in Frame 2. The length of material web is set by the position of the sensor reflector 378 on the vacuum platen and is arranged to coincide with the width of the board. In Frame 3, the platen is lowered by the actuator 373 to abut the film lying on the table. At this stage, the vacuum to the table has been removed, that is, switched OFF to release the film, and the vacuum has been switched ON in the platen. The actuator lifts the platen with the material web attached, as illustrated in Frame 4 and moves along the carriage 372 to overlie the board, drawing new lining material from the reel 355 and dancing arm 379 arrangement onto the table, as shown in Frame 5.

In Frame 6, the platen is lowered onto the board by the actuator 373 which applies sufficient downward pressure to ensure the film is bonded to the adhesive applied to the board. The vacuum is switched OFF at the platen, to release the material web lining the container blank, and switched ON at the table to secure the newly introduced material. The knife 374 is then moved into its slotted anvil 375, slicing the film in line with the edge of the board, as shown in Frame 7. At this point, the platen is withdrawn to the position shown in Frame 8. The stop 353 is withdrawn and the lined container blank 300 is discharged as a new board blank is introduced to complete the lining cycle.

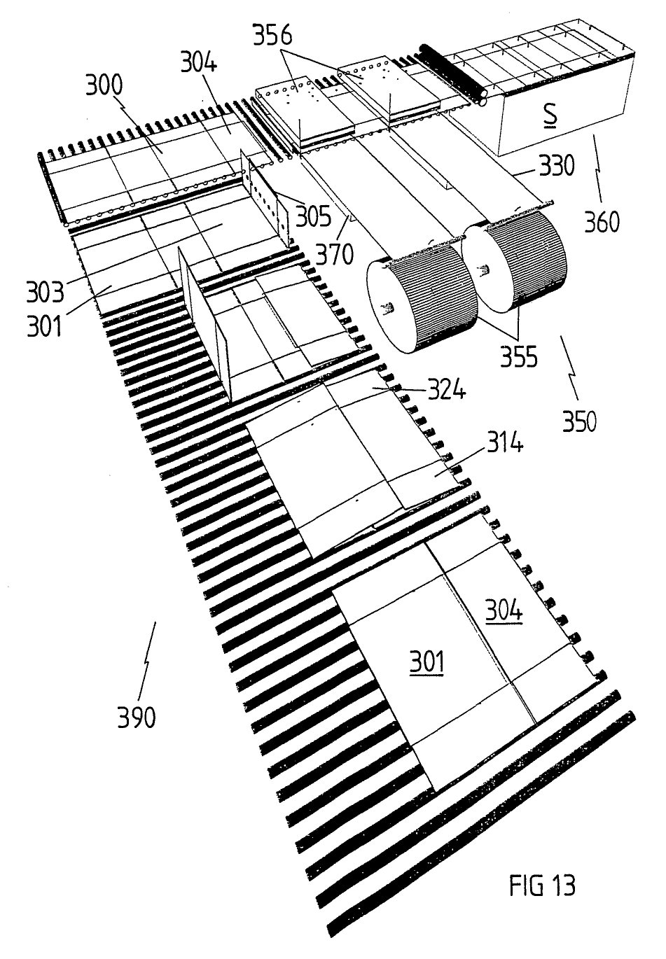

Finally, with reference to FIG. 13, the discharge conveyor 290 is disposed at the end of the support conveyor 359 of the lining apparatus 350. This discharge conveyor includes one or more additional stations to either fold the container blank 300 for convenient storage or to fold the container blank into an intermediate container form. In the arrangement illustrated, a trailing wall portion 304 of the blank has a fixing tab 305 attached thereto. As the container blank 300 is introduced to the discharge conveyor, the opposite end wall portion 301 of the blank has a strip of adhesive applied thereto by an adhesive applicator, in this case, a hot-melt gun. At the same time, a folding actuator (not shown), folds the trailing wall portion 304 and its associated lid portion 324 and base portion 314 to overlie its attached adjacent wall portion 303. The opposite wall portion 301 is also folded and it is positioned to overlie the fixing tab 305 so that the adhesive strip is aligned therewith. Pressure is applied to that region, for example, by a pressure roller to ensure adhesion. For larger containers, staples may be added along that region to reinforce the bond.

The container blank 300 whether folded or in intermediate container form is then discharged for storage, further forming into open-mouthed containers or may be conveyed for packaging articles.

It will be appreciated that the apparatus and methods for filling, article securing and container sealing as already described herein, for example, with reference to FIG. 7 and FIGS. 8a to 8c, may be applied to the container blanks 200,300 of FIGS. 9a and 9b.

It will of course be understood that the invention is not limited to the specific details described herein, which are given by way of example only, and that various modifications and alterations are possible within the scope of the appended claims.

1. A container or container blank comprising:
a pair of opposed side wall portions and an opposed front wall portion and rear wall portion, each wall portion being connected to a base portion at a fold line and at least one opposed pair of walls being provide with a lid section; and
at least one portion having attached thereto a web of material adapted to retain an article within the container or a container formed from the blank,
wherein the material web is secured to the at least one portion using adhesive applied in a direction consistent with the direct along which tension is applied to retain an article within the container.

2. A container or container blank as claimed in claim 1, in which:
the side wall portions and front and rear wall portions are connected to a common base portion at respective fold lines;
each side wall portion has inner and outer sections, separated by a fold land, the sections being adapted for folding about the fold land to assume a position overlying one another, the outer section including locking means engagable in the base portion to secure said overlying position; and
the front and rear wall portions each have a riser section and a lid section.

3. A container or container blank as claimed in claim 1, in which each wall portion has a base portion and lid section attached thereto at fold lines and is connected to at least one adjacent wall portion at a fold line disposed perpendicularly to the base or lid fold lines.

4. A container or container blank as claimed in claim 1, in which the material web is secured to the at least one portion using adhesive applied in a direction consistent with the direction in which the web is applied.

5. A container or container blank as claimed in claim 1, in which the adhesive is selected from hot melt glue, cold-seal contact adhesive, double-sided adhesive tape or like material.

6. A container or container blank as claimed in claim 1, in which the material adapted to retain an article within the container or container formed from the blank is a shrink-wrappable material.

7. A container or container blank as claimed in claim 1, in which the material adapted to retain an article within the container or container formed from the blank includes an adhesive coated section having an adhesive material adapted to adhere substantially exclusively to like coated sections.

8. A container or container blank as claimed in claim 1, in which the material web includes at least one adhesive coated section to which a removable liner is applied.

9. A container or container blank as claimed in claim 7, in which the material web includes a release coat.

10. A container or container blank as claimed in claim 1, in which at least the side, front and rear wall portions are so sized and shaped as to be machine foldable.

11. A container or container blank as claimed in claim 1, in which the container or container blank is cut from a card material having a nape oriented to add to the strength of the container or container formed from the blank.

12. A container or container blank as claimed in claim 1, in which the web is applied discontinuously.

13. An apparatus for forming a container blank of the type having an article retaining means thereon, the apparatus comprising:
means for dispensing onto a feed conveyor a substantially continuous supply of container blanks, the blanks being of a desirous pre-formed profile having a plurality of foldable sections so shaped and sized as to form a container;
means for applying adhesive;
means for dispensing a web of a retaining material and laying a length of said web onto the inner surface of said blank;
cutting means to slice the web to define the length of web adhered to the blank; and
conveying means to carry the blank thus formed to a stacking station, a storage station or for further processing.

14. An apparatus for forming a container blank as claimed in claim 13, in which the apparatus includes a pressure applying means for bonding the web material to the inner surface of the blank.

15. An apparatus for forming a container blank as claimed in claim 13, in which the means for dispensing a supply of blanks comprises a support table having a vacuum operated picker mechanism which individually selects a blank from the base of a magazine of blanks and introduces the blank to an adhesive application station.

16. An apparatus for forming a container blank as claimed in claim 15, in which the table includes a blank edge support means for retaining the blanks within the magazine, the picker mechanism engaging the base portion of the selected blank and deflecting it to disengage said edge support means.

17. An apparatus for forming a container blank as claimed in claim 13, in which the means for dispensing a supply of blanks comprises a means for conveying a stack of blanks to a vacuum operated picker mechanism which is adapted to select individually the trailing edge region of a blank and introduce the leading edge thereof to an adhesive application station.

18. An apparatus for forming a container blank as claimed in claims 17, in which the vacuum picker mechanism is mounted on a carriage adapted for parallel movement with respect to the direction of travel of the blanks, whereby successive blanks are peeled from underlying blanks in a stack of blanks.

19. An apparatus for forming a container blank as claimed in claim 13, in which the means for dispensing a supply of blanks comprises a pair of lift tables mounted on a carriage adapted for lateral movement with respect to the direction of travel of blanks within the apparatus, the dispensing means including a vacuum operated picker mechanism which individually selects a blank from the top of a magazine of blanks and introduces the blank to an adhesive application station.

20. An apparatus for forming a container blank as claimed in claim 13, in which the means for applying adhesive comprises a plurality of nozzles for applying at least one strip of a flowable adhesive to an inner surface of the blank.

21. An apparatus for forming a container blank as claimed in claim 13, in which the means for applying adhesive comprises a tape dispenser for applying double-sided adhesive tape to a length of said web or to the inner surface of said blank.

22. An apparatus for forming a container blank as claimed in claim 13, in which the cutting means defines first and second lengths of web material adhered to the blank.

23. An apparatus for forming a container blank as claimed in claim 13, in which the conveying means includes a forming station adapted to fold the blank into a profile suitable for stacking or as an intermediate container forming stage.

24. An apparatus for forming a container blank as claimed in claim 23, in which the forming station includes as adhesive application station.

25. An apparatus for forming a container blank as claimed in claim 23, in which the forming station includes a stapling means.

26. A method for forming a container blank of the type having an article retaining portion thereon, the method comprising:
dispensing onto a feed conveyor a substantially continuous supply of container blanks, the blanks being of a desirous pre-formed profile having a plurality of foldable sections so shaped and sized as to form a container;
applying at least one strip of adhesive for bonding a web of retaining material to inner surface of the blank;
dispensing the web of a retaining material and laying a length of said web onto the inner surface of said blank;
cutting the web to define the length of web adhered to the blank; and
conveying the blank thus formed to a stacking station, a storage station or for further processing.

27. A method for forming a container blank as claimed in claim 26, in which the method includes applying pressure to the inner surface of the blank to bond the web material thereto.

28. A method for forming a container blank as claimed in claim 26, in which first and second lengths of web are cut and adhered to the blank.

29. A method as claimed in claim 26, in which the or each strip of adhesive is applied to the web of retaining material.

30. A method as claimed in claim 26, in which the or each strip of adhesive is applied via a tape dispenser.

31. A method as claimed in claim 26, in which the or each strip of adhesive is applied to the inner surface of the blank via a plurality of nozzles.

32. An apparatus for forming a container from a container blank of the type having an article retaining portion thereon, the apparatus comprising:
a feeding station for dispensing onto a feed conveyor a substantially continuous supply of container blanks, each blank having a length of web material adhered thereto and having a plurality of foldable sections so shaped and sized as to form a container; and
a container forming station having at least one actuator member to abut or grip a portion of the container blank so as to cause sections of the blank to move about pre-formed score lines so that the blank assumes the form of an open-mouthed container.

33. An apparatus for forming a container as claimed in claims 32, in which the at least one actuator member abuts the inner surface of the base portion of the container blank and forces the blank into a container-forming die, the die being so formed and shaped as to cause sections of the blank to fold about pre-formed score lines.

34. An apparatus for forming a container as claimed in claims 32, in which the at least one actuator member is a vacuum operated mechanism adapted to open a folded container blank so as to facilitate forming of a container base from a plurality of base portions, whereupon the blank assumes the form of an open-mouthed container.

35. An apparatus for forming a container as claimed in claim 32, the apparatus including any one or more of:
at least one packing station where one or more articles are placed into the open mouth of the formed container;
an article retaining station where manipulator means bring one end of the web material into position to overlie the other end and adhere the overlying sections together;
lid closing station where the lid portions are brought together in overlying relationship to seal the lid closed; and
a dispatch conveyor which carries the container through final stages or to storage.

36. An apparatus for forming a container as claimed in claim 32, in which the feeding station comprises an apparatus for forming a container blank in accordance with claim 13.

37. An apparatus for forming a container as claimed in claim 32, in which there is provided a shrink-wrapping station where heat is applied to the overlying ends of shrink-wrappable web material so that the or each article placed in the container at the packing station is secured therein.

38. An apparatus for forming a container as claimed in claim 35, in which pressure-sensitive adhesive is pre-applied to at least one of the lid portions to facilitate sealing of the container at the lid closing station.

39. An apparatus for forming a container as claimed in claim 35, in which the lid closing station comprises at least one tape dispenser to seal the container.

40. An apparatus for forming a container as claimed in claim 35, in which the lid closing station includes means for securing the base portions of the container.

41. An apparatus for forming a container as claimed in claim 32, in which the feeding station comprises a pivotable destacking arm adapted to individually select a blank from magazine of vertically stacked blanks.

42. An apparatus for forming a container as claimed in claim 32, in which the feeding station comprises a pair of lift tables mounted on a carriage adapted for lateral movement with respect to the direction of travel of blanks within the apparatus, the dispensing means including a vacuum operated picker mechanism which individually selects a blank from the top of a magazine of blanks and introduces the blank to an adhesive application station.

43. A method of forming a container from a container blank of the type having an article retaining portion thereon, the method comprising:
dispensing onto a feed conveyor a substantially continuous supply of container blanks, each blank having a length of retaining material adhered thereto and having a plurality of foldable sections so shaped and sized as to form a container; and
abutting or gripping a portion of the container blank with at least one actuator member so as to cause sections of the blank to move about pre-formed score lines so that the blank assumes the form of an open-mouthed container.

44. A method of forming a container as claimed in claim 43, which includes abutting the inner surface of the base portion of the container blank and forcing the blank into a container-forming die, the die being so formed and shaped as to cause sections of the blank to fold about pre-formed score lines.

45. A method of forming a container as claimed in claim 43, which includes opening a folded container blank by gripping a surface thereof with a vacuum operated actuator mechanism, forming a container base from a plurality of base portions thereby forming an open-mouthed container.

46. A method of forming a container as claimed in claim 43, the method including one or more steps selected from:
placing one or more articles into the open mouth of the formed container;
bringing one end of the retaining material into position to overlie the other end and adhering the overlying sections together;
closing the lid portions in overlying relationship to seal the lid closed; and conveying the container through final stages or to storage; and
conveying the container through final stages or to storage.

47. A method of forming a container as claimed in claim 46, which includes applying heat to the overlying ends of the material so as to secure the or each article placed in the container.

48. A method of forming a container as claimed in claim 46, in which pressure-sensitive adhesive is pre-applied to at least one of the lid portions to facilitate sealing of the container at the lid closing station.

49. A method of forming a container as claimed in claim 46, including dispensing and applying adhesive tape to secure the or each lid portion and/or the or each base portion.

50. An apparatus for feeding open-mouthed containers via a packing station to a sealing and closing station in preparation for dispatch or storage of the packaged articles, the apparatus comprising:
feeding means for conveying open-mouthed containers onto a buffer conveyor;
a stacking conveyor comprising at least one intake conveyor fed by the buffer conveyor;
a discharge conveyor for transporting filled containers from a packing station;
an article securing station where free ends of the retaining material are brought together and bonded to secure the or each article within the container; and
a lid closing means.

51. An apparatus as claimed in claim 50, in which a heating zone is provided for applying heat to a shrink-wrap retaining means within the containers to secure the contents therein.

52. A method of feeding open-mouthed containers via a packing station to a sealing and closing station in preparation for dispatch or storage of the packaged articles, the method comprising:
feeding open-mouthed containers onto a buffer conveyor;
feeding containers from said buffer conveyor to a stacking conveyor;
filling the containers at a packing station and placing the filled containers on a discharge conveyor;
securing free ends of a retaining material by bringing the ends together for bonding to secure the or each article within the container; and
closing and sealing the or each lid portion of the container.

53. A method as claimed in claim 52, which includes applying heat to a shrink-wrappable retaining means within the container to secure the contents therein.

54. A method as claimed in claim 52, which includes removing lining or backing material from the retaining material to expose adhesive thereon and tensioning said material to secure the contents of the container therein.

55-59. (canceled)
